(19) United States
(12) Patent Application Publication
(10) Pub. No.: US 2022/0327005 A1
(43) Pub. Date: Oct. 13, 2022

(54) METHODS AND APPARATUS TO LOAD BALANCE EDGE DEVICE WORKLOADS

(71) Applicant: Intel Corporation, Santa Clara, CA (US)

(72) Inventors: Alejandro Ibarra Von Borstel, Manchaca, TX (US); Hector Cordourier Maruri, Gudalajara (MX); Jose Rodrigo Camacho Perez, Gudalajara (MX); Julio Zamora Esquivel, West Sacramento, CA (US); Paulo Lopez Meyer, Zapopan (MX)

(21) Appl. No.: 17/846,797

(22) Filed: Jun. 22, 2022

(51) Int. Cl. G06F 9/50; G06N 7/00

(52) U.S. Cl. CPC G06F 9/5083; G06N 7/005

(57) ABSTRACT

Methods, apparatus, systems, and articles of manufacture are disclosed. An example apparatus includes at least one memory; instructions; and processor circuitry to execute the instructions. The processor circuitry executes the instructions to extract static and dynamic data from a packet associated with a request for service by an edge device, the static data to change less frequently than the dynamic data. The processor circuitry executes the instructions to generate a first plurality of probability distributions using the static data. The processor circuitry executes the instructions to generate a second plurality of probability distributions using the dynamic data. The processor circuitry executes the instructions to calculate a confidence value for a first helper compute unit of a plurality of helper compute units, the confidence value. The processor circuitry executes the instructions to assign the first helper compute unit the request for service based on the confidence value.

### FIELD OF THE DISCLOSURE

This disclosure relates generally to networking and, more particularly, to load balancing for Edge devices.

### BACKGROUND

Edge network environments enable services near endpoint devices that interact with the services. Edge network environments may include infrastructure, such as a base station or micro datacenter hosting an Edge service, that is connected to cloud infrastructure, endpoint devices, or additional Edge infrastructure via networks such as a wide area network (WAN), a metropolitan area network (MAN), or (more generally) the internet. Edge services are generally closer in network proximity to endpoint devices than cloud infrastructure, such as datacenter servers.

### BRIEF DESCRIPTION OF THE DRAWINGS

FIG. 1 illustrates an overview of an example Edge cloud configuration for Edge computing.

FIG. 2 illustrates operational layers among endpoints, an example Edge cloud, and cloud computing environments.

FIG. 3 illustrates an example approach for networking and services in an Edge computing system.

FIG. 4 is a block diagram of an example dynamic load balancer.

FIG. 5 is an illustration of example bayesian deep learning models and example confidence tables of the example dynamic load balancer of FIG. 4.

FIG. 6 is an illustration of the example confidence tables of FIG. 5 and an example confidence graph generated by the example dynamic load balancer of FIG. 4.

FIG. 7 is a table including data for training the example bayesian deep learning model of FIG. 5.

FIG. 8 is a flowchart representative of example machine readable instructions and/or example operations that may be executed by example processor circuitry to implement the dynamic load balancer of FIG. 4.

FIG. 9 is a flowchart representative of example machine readable instructions and/or example operations that may be executed by example processor circuitry to calculate confidence coefficients for helper compute units.

FIG. 10 is a flowchart representative of example machine readable instructions and/or example operations that may be executed by example processor circuitry to train the bayesian neural networks of the example dynamic load balancer of FIG. 4.

FIG. 11 is a block diagram of an example processing platform including processor circuitry structured to execute the example machine readable instructions and/or the example operations of FIG. 3 to implement the dynamic load balancer of FIGS. 1-4.

FIG. 12 is a block diagram of an example implementation of the processor circuitry of FIG. 11.

FIG. 13 is a block diagram of another example implementation of the processor circuitry of FIG. 11.

FIG. 14 is a block diagram of an example software distribution platform (e.g., one or more servers) to distribute software (e.g., software corresponding to the example machine readable instructions of FIGS. 8-10) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not to scale. Instead, the thickness of the layers or regions may be enlarged in the drawings. Although the figures show layers and regions with clean lines and boundaries, some or all of these lines and/or boundaries may be idealized. In reality, the boundaries and/or lines may be unobservable, blended, and/or irregular.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

Notwithstanding the foregoing, in the case of a semiconductor device, “above” is not with reference to Earth, but instead is with reference to a bulk region of a base semiconductor substrate (e.g., a semiconductor wafer) on which components of an integrated circuit are formed. Specifically, as used herein, a first component of an integrated circuit is “above” a second component when the first component is farther away from the bulk region of the semiconductor substrate than the second component.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified in the below description. As used herein “substantially real time” refers to occurrence in a near instantaneous manner recognizing there may be real world delays for computing time, transmission, etc. Thus, unless otherwise specified, “substantially real time” refers to real time+/−1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “processor circuitry” is defined to include (i) one or more special purpose electrical circuits structured to perform specific operation(s) and including one or more semiconductor-based logic devices (e.g., electrical hardware implemented by one or more transistors), and/or (ii) one or more general purpose semiconductor-based electrical circuits programmable with instructions to perform specific operations and including one or more semiconductor-based logic devices (e.g., electrical hardware implemented by one or more transistors). Examples of processor circuitry include programmable microprocessors, Field Programmable Gate Arrays (FPGAs) that may instantiate instructions, Central Processor Units (CPUs), Graphics Processor Units (GPUs), Digital Signal Processors (DSPs), XPUs, or microcontrollers and integrated circuits such as Application Specific Integrated Circuits (ASICs). For example, an XPU may be implemented by a heterogeneous computing system including multiple types of processor circuitry (e.g., one or more FPGAs, one or more CPUs, one or more GPUs, one or more DSPs, etc., and/or a combination thereof) and application programming interface(s) (API(s)) that may assign computing task(s) to whichever one(s) of the multiple types of processor circuitry is/are best suited to execute the computing task(s).

### DETAILED DESCRIPTION

Edge computing is a distributed computing scheme that brings computation and data storage close to the physical location at which it is needed. Reducing distance between data computation devices and data generating devices reduces data transport latency, as data is not sent across long distances. In Edge computing, data is stored and processed near end-point devices, improving response time, saving bandwidth, and improving reliability. Additionally, Edge computing systems may still communicate with cloud devices (e.g., datacenters) when workloads exceed local compute and/or storage capabilities.

Smart Edge devices are increasingly capable of executing on-device machine learning workloads that traditionally demanded powerful servers. In machine learning, instead of providing explicit instructions, programmers use a trained machine learning model and supply data to the model. The model generates predictions and, in some examples, trains itself to improve prediction accuracy. Programmers can also adjust model parameters to further improve prediction accuracy. Although Edge devices are increasingly performant, many Edge devices cannot meet execution thresholds for deep learning workloads. For example, surveillance workloads, assisted driving workloads, and healthcare workloads may be associated with low latency performance thresholds that some Edge devices cannot meet.

Some smart Edge devices are connected to one or more Edge servers capable of receiving a request to distribute a machine learning workload. For example, a smart Edge device may send a request for service to an Edge server. In response, the Edge server may distribute portions of the workload to one or more helper devices (e.g., helper compute devices, smart edge devices, Edge servers, cloud servers, etc.) in a process called load balancing.

Conventional load balancing techniques used by Edge servers include hashing and MapReduce-based methods. Hash-based load balancing techniques map a workload to one or more servers, calculate run time weights for each server, and assign the workload to the one or more servers. Hash function based load balancing techniques are often unable to efficiently handle the rapidly changing workloads produced with Edge devices.

MapReduce-based load balancing techniques filter and sort portions of a workload, and then aggregate the results. Although frequently used, MapReduce-based load balancing techniques often produce insufficient results when handling skewed data. Other conventional load balancing techniques such as binary offloading (e.g., rule-based load balancing techniques that weighs factors such as network latency, bandwidth, device energy, and monetary cost) are rigid and fail to meet performance the demands of dynamically changing variables (e.g., geography, cloud traffic hours, location, and device mobility) associated with deep learning workloads of Edge devices.

In contrast to conventional solutions, examples disclosed herein dynamically load balance machine learning workloads at the Edge. Some examples disclosed herein include dynamic hardware and/or software load balancers to distribute portions of a machine learning workload from an Edge server to one or more Edge compute units (e.g., Edge servers, Edge load balancers, Edge endpoint devices). Furthermore, the techniques describe herein improve performance on deep learning workloads and/or any Edge workload with dynamic and static data.

Some examples disclosed herein include an example dynamic load balancer. The example dynamic load balancer produces a confidence level for one or more helper compute units (e.g., helper Edge devices, helper cloud devices, etc.) based on data received in a request for service from an Edge device. The example dynamic load balancer then distributes the workload from the request based on static and dynamic data received in the request. In some examples, the static data is provided to a first machine learning model and the dynamic data is provided to a second machine learning model, and each of the machine learning models generates a plurality of probability distributions. Each of the plurality of probability distributions is associated with a helper node.

Additionally, in some examples dynamic load balancer trains the first and second machine learning models based on results of a third machine learning model. The example dynamic load balancer may perform inference with two bayesian deep neural networks (e.g., bayesian neural network) that quantify uncertainty in model predictions. Thus, the bayesian neural network generating a probability distribution instead of a single point estimate.

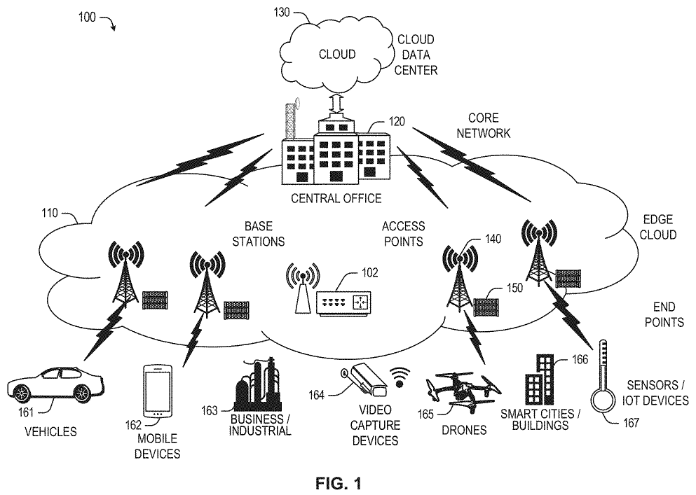

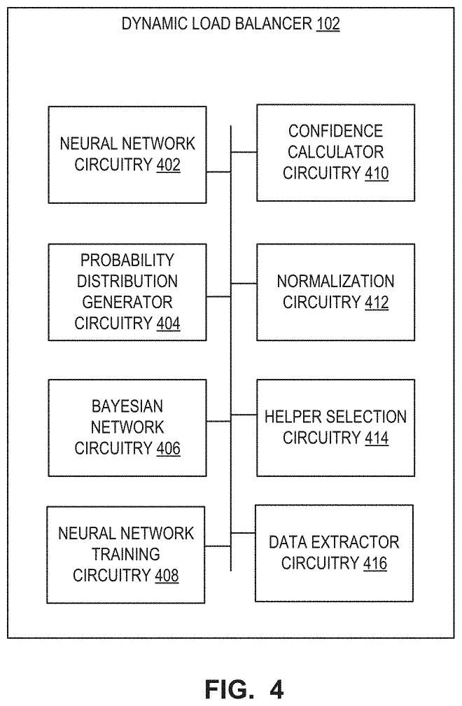

Turning to the figures, FIG. 1 is a block diagram 100 showing an overview of a configuration for Edge computing, which includes a layer of processing referred to in many of the following examples as an “Edge cloud”. As shown, the Edge cloud 110 is co-located at an Edge location, such as an access point or base station 140, a local processing hub 150, or a central office 120, and thus may include multiple entities, devices, and equipment instances. The example edge cloud 110 also includes an example dynamic load balancer 102. The structure and operation of the example dynamic load balancer 102 will be described further in connection with FIGS. 4-6. The Edge cloud 110 is located much closer to the endpoint (consumer and producer) data sources 161-167 (e.g., autonomous vehicles 161, user equipment 162, business and industrial equipment 163, video capture devices 164, drones 165, smart cities and building devices 166, sensors and IoT devices 167, etc.) than the cloud data center 130. Compute, memory, and storage resources which are offered at the edges in the Edge cloud 110 are critical to providing ultra-low latency response times for services and functions used by the endpoint data sources 160 as well as reduce network backhaul traffic from the Edge cloud 110 toward cloud data center 130 thus improving energy consumption and overall network usages among other benefits.

Compute, memory, and storage are scarce resources, and generally decrease depending on the Edge location (e.g., fewer processing resources being available at consumer endpoint devices, than at a base station, than at a central office). However, the closer that the Edge location is to the endpoint (e.g., user equipment (UE)), the more that space and power is often constrained. Thus, Edge computing attempts to reduce the amount of resources needed for network services, through the distribution of more resources which are located closer both geographically and in network access time. In this manner, Edge computing attempts to bring the compute resources to the workload data where appropriate, or bring the workload data to the compute resources.

The following describes aspects of an Edge cloud architecture that covers multiple potential deployments and addresses restrictions that some network operators or service providers may have in their own infrastructures. These include, variation of configurations based on the Edge location (because edges at a base station level, for instance, may have more constrained performance and capabilities in a multi-tenant scenario); configurations based on the type of compute, memory, storage, fabric, acceleration, or like resources available to Edge locations, tiers of locations, or groups of locations; the service, security, and management and orchestration capabilities; and related objectives to achieve usability and performance of end services. These deployments may accomplish processing in network layers that may be considered as “near Edge”, “close Edge”, “local Edge”, “middle Edge”, or “far Edge” layers, depending on latency, distance, and timing characteristics.

Edge computing is a developing paradigm where computing is performed at or closer to the “Edge” of a network, typically through the use of a compute platform (e.g., x86 or ARM compute hardware architecture) implemented at base stations, gateways, network routers, or other devices which are much closer to endpoint devices producing and consuming the data. For example, Edge gateway servers may be equipped with pools of memory and storage resources to perform computation in real-time for low latency use-cases (e.g., autonomous driving or video surveillance) for connected client devices. Or as an example, base stations may be augmented with compute and acceleration resources to directly process service workloads for connected user equipment, without further communicating data via backhaul networks. Or as another example, central office network management hardware may be replaced with standardized compute hardware that performs virtualized network functions and offers compute resources for the execution of services and consumer functions for connected devices. Within Edge computing networks, there may be scenarios in services which the compute resource will be “moved” to the data, as well as scenarios in which the data will be “moved” to the compute resource. Or as an example, base station compute, acceleration and network resources can provide services in order to scale to workload demands on an as needed basis by activating dormant capacity (subscription, capacity on demand) in order to manage corner cases, emergencies or to provide longevity for deployed resources over a significantly longer implemented lifecycle.

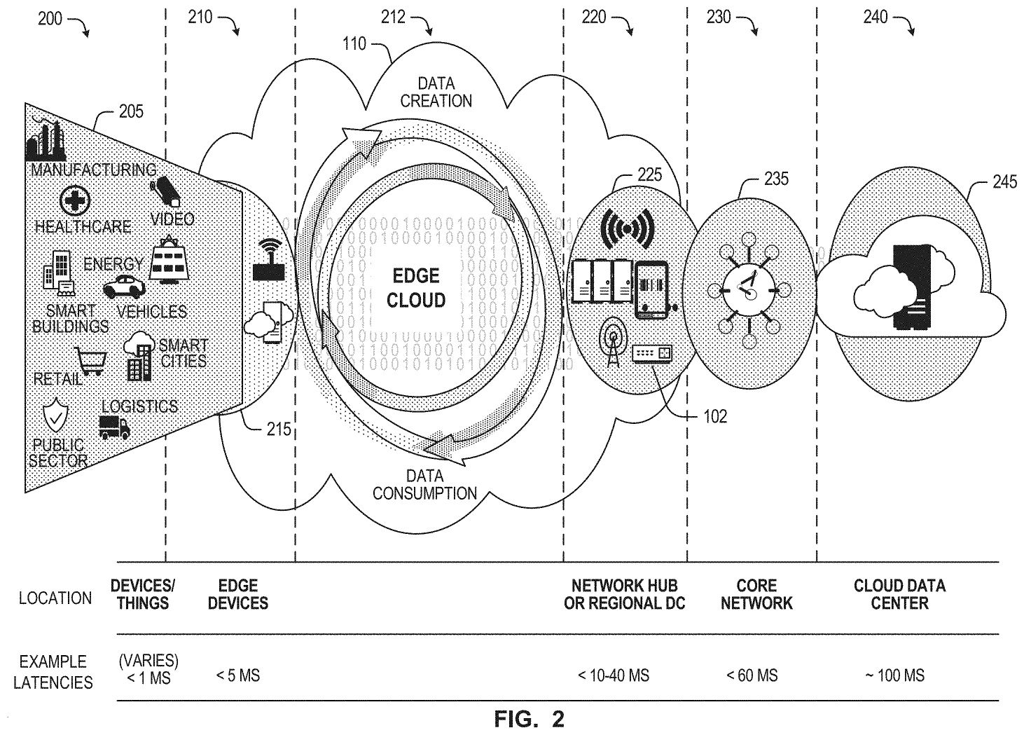

FIG. 2 illustrates operational layers among endpoints, an Edge cloud, and cloud computing environments. Specifically, FIG. 2 depicts examples of computational use cases 205, utilizing the Edge cloud 110 among multiple illustrative layers of network computing. The layers begin at an endpoint (devices and things) layer 200, which accesses the Edge cloud 110 to conduct data creation, analysis, and data consumption activities. The Edge cloud 110 may span multiple network layers, such as an Edge devices layer 210 having gateways, on-premise servers, or network equipment (nodes 215) located in physically proximate Edge systems; a network access layer 220, encompassing base stations, radio processing units, network hubs, regional data centers (DC), or local network equipment (equipment 225 including the example dynamic load balancer 102); and any equipment, devices, or nodes located therebetween (in layer 212, not illustrated in detail). The network communications within the Edge cloud 110 and among the various layers may occur via any number of wired or wireless mediums, including via connectivity architectures and technologies not depicted. For example, the dynamic load balancer may operate in the example Edge devices layer 210 or in any part of layer 212.

Examples of latency, resulting from network communication distance and processing time constraints, may range from less than a millisecond (ms) when among the endpoint layer 200, under 5 ms at the Edge devices layer 210, to even between 10 to 40 ms when communicating with nodes at the network access layer 220. Beyond the Edge cloud 110 are core network 230 and cloud data center 240 layers, each with increasing latency (e.g., between 50-60 ms at the core network layer 230, to 100 or more ms at the cloud data center layer). As a result, operations at a core network data center 235 or a cloud data center 245, with latencies of at least 50 to 100 ms or more, will not be able to accomplish many time-critical functions of the use cases 205. Each of these latency values are provided for purposes of illustration and contrast; it will be understood that the use of other access network mediums and technologies may further reduce the latencies. In some examples, respective portions of the network may be categorized as “close Edge”, “local Edge”, “near Edge”, “middle Edge”, or “far Edge” layers, relative to a network source and destination. For instance, from the perspective of the core network data center 235 or a cloud data center 245, a central office or content data network may be considered as being located within a “near Edge” layer (“near” to the cloud, having high latency values when communicating with the devices and endpoints of the use cases 205), whereas an access point, base station, on-premise server, or network gateway may be considered as located within a “far Edge” layer (“far” from the cloud, having low latency values when communicating with the devices and endpoints of the use cases 205). It will be understood that other categorizations of a particular network layer as constituting a “close”, “local”, “near”, “middle”, or “far” Edge may be based on latency, distance, number of network hops, or other measurable characteristics, as measured from a source in any of the network layers 200-240.

The various use cases 205 may access resources under usage pressure from incoming streams, due to multiple services utilizing the Edge cloud. To achieve results with low latency, the services executed within the Edge cloud 110 balance varying requirements in terms of: (a) Priority (throughput or latency) and Quality of Service (QoS) (e.g., traffic for an autonomous car may have higher priority than a temperature sensor in terms of response time requirement; or, a performance sensitivity/bottleneck may exist at a compute/accelerator, memory, storage, or network resource, depending on the application); (b) Reliability and Resiliency (e.g., some input streams need to be acted upon and the traffic routed with mission-critical reliability, where as some other input streams may be tolerate an occasional failure, depending on the application); and (c) Physical constraints (e.g., power, cooling and form-factor, etc.).

The end-to-end service view for these use cases involves the concept of a service-flow and is associated with a transaction. The transaction details the overall service requirement for the entity consuming the service, as well as the associated services for the resources, workloads, workflows, and business functional and business level requirements. The services executed with the “terms” described may be managed at each layer in a way to assure real time, and runtime contractual compliance for the transaction during the lifecycle of the service. When a component in the transaction is missing its agreed to Service Level Agreement (SLA), the system as a whole (components in the transaction) may provide the ability to (1) understand the impact of the SLA violation, and (2) augment other components in the system to resume overall transaction SLA, and (3) implement remediation.

Thus, with these variations and service features in mind, Edge computing within the Edge cloud 110 may provide the ability to serve and respond to multiple applications of the use cases 205 (e.g., object tracking, video surveillance, connected cars, etc.) in real-time or near real-time, and meet ultra-low latency requirements for these multiple applications. These advantages enable a whole new class of applications (e.g., Virtual Network Functions (VNFs), Function as a Service (FaaS), Edge as a Service (EaaS), standard processes, etc.), which cannot leverage conventional cloud computing due to latency or other limitations.

However, with the advantages of Edge computing comes the following caveats. The devices located at the Edge are often resource constrained and therefore there is pressure on usage of Edge resources. Typically, this is addressed through pooling of memory and storage resources for use by multiple users (tenants) and devices. The Edge may be power and cooling constrained and therefore the power usage needs to be accounted for by the applications that are consuming the most power. There may be inherent power-performance tradeoffs in these pooled memory resources, as many of them are likely to use emerging memory technologies, where more power requires greater memory bandwidth. Likewise, improved security of hardware and root of trust trusted functions are also required, because Edge locations may be unmanned and may even need permissioned access (e.g., when housed in a third-party location). Such issues are magnified in the Edge cloud 110 in a multi-tenant, multi-owner, or multi-access setting, where services and applications are requested by many users, especially as network usage dynamically fluctuates and the composition of the multiple stakeholders, use cases, and services changes.

At a more generic level, an Edge computing system may be described to encompass any number of deployments at the previously discussed layers operating in the Edge cloud 110 (network layers 200-240), which provide coordination from client and distributed computing devices. One or more Edge gateway nodes, one or more Edge aggregation nodes, and one or more core data centers may be distributed across layers of the network to provide an implementation of the Edge computing system by or on behalf of a telecommunication service provider (“telco”, “CommSP”, or “TSP”), internet-of-things service provider, cloud service provider (CSP), enterprise entity, or any other number of entities. Various implementations and configurations of the Edge computing system may be provided dynamically, such as when orchestrated to meet service objectives.

Consistent with the examples provided herein, a client compute node may be embodied as any type of endpoint component, device, appliance, or other thing capable of communicating as a producer or consumer of data. Further, the label “node” or “device” as used in the Edge computing system does not necessarily mean that such node or device operates in a client or agent/minion/follower role; rather, any of the nodes or devices in the Edge computing system refer to individual entities, nodes, or subsystems which include discrete or connected hardware or software configurations to facilitate or use the Edge cloud 110.

As such, the Edge cloud 110 is formed from network components and functional features operated by and within Edge gateway nodes, Edge aggregation nodes, or other Edge compute nodes among network layers 210-230. The Edge cloud 110 thus may be embodied as any type of network that provides Edge computing and/or storage resources which are proximately located to radio access network (RAN) capable endpoint devices (e.g., mobile computing devices, IoT devices, smart devices, etc.), which are discussed herein. In other words, the Edge cloud 110 may be envisioned as an “Edge” which connects the endpoint devices and traditional network access points that serve as an ingress point into service provider core networks, including mobile carrier networks (e.g., Global System for Mobile Communications (GSM) networks, Long-Term Evolution (LTE) networks, 5G/6G networks, etc.), while also providing storage and/or compute capabilities. Other types and forms of network access (e.g., Wi-Fi, long-range wireless, wired networks including optical networks, etc.) may also be utilized in place of or in combination with such 3GPP carrier networks.

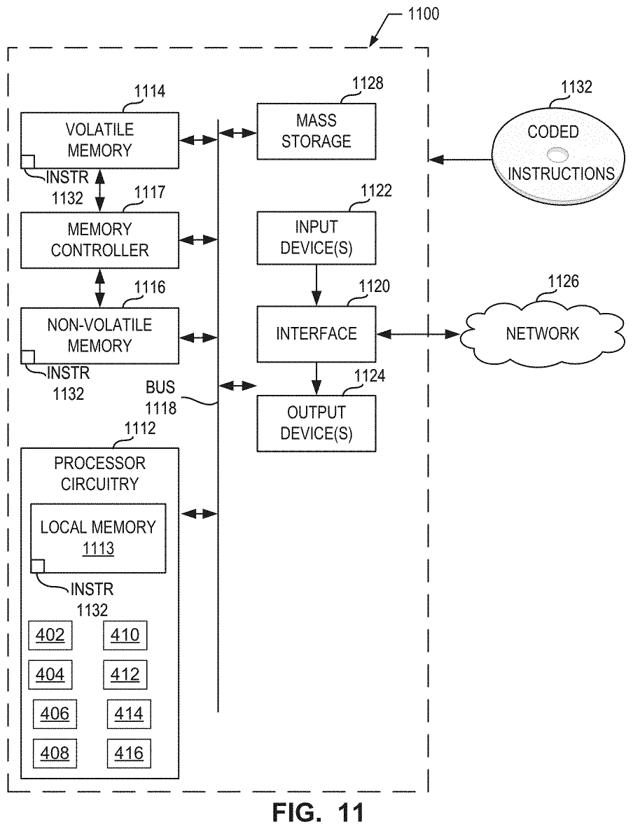

The network components of the Edge cloud 110 may be servers, multi-tenant servers, appliance computing devices, and/or any other type of computing devices. For example, the Edge cloud 110 may include an appliance computing device that is a self-contained electronic device including a housing, a chassis, a case, or a shell. In some circumstances, the housing may be dimensioned for portability such that it can be carried by a human and/or shipped. Example housings may include materials that form one or more exterior surfaces that partially or fully protect contents of the appliance, in which protection may include weather protection, hazardous environment protection (e.g., electromagnetic interference (EMI), vibration, extreme temperatures, etc.), and/or enable submergibility. Example housings may include power circuitry to provide power for stationary and/or portable implementations, such as alternating current (AC) power inputs, direct current (DC) power inputs, AC/DC converter(s), DC/AC converter(s), DC/DC converter(s), power regulators, transformers, charging circuitry, batteries, wired inputs, and/or wireless power inputs. Example housings and/or surfaces thereof may include or connect to mounting hardware to enable attachment to structures such as buildings, telecommunication structures (e.g., poles, antenna structures, etc.), and/or racks (e.g., server racks, blade mounts, etc.). Example housings and/or surfaces thereof may support one or more sensors (e.g., temperature sensors, vibration sensors, light sensors, acoustic sensors, capacitive sensors, proximity sensors, infrared or other visual thermal sensors, etc.). One or more such sensors may be contained in, carried by, or otherwise embedded in the surface and/or mounted to the surface of the appliance. Example housings and/or surfaces thereof may support mechanical connectivity, such as propulsion hardware (e.g., wheels, rotors such as propellers, etc.) and/or articulating hardware (e.g., robot arms, pivotable appendages, etc.). In some circumstances, the sensors may include any type of input devices such as user interface hardware (e.g., buttons, switches, dials, sliders, microphones, etc.). In some circumstances, example housings include output devices contained in, carried by, embedded therein and/or attached thereto. Output devices may include displays, touchscreens, lights, light-emitting diodes (LEDs), speakers, input/output (I/O) ports (e.g., universal serial bus (USB)), etc. In some circumstances, Edge devices are devices presented in the network for a specific purpose (e.g., a traffic light), but may have processing and/or other capacities that may be utilized for other purposes. Such Edge devices may be independent from other networked devices and may be provided with a housing having a form factor suitable for its primary purpose; yet be available for other compute tasks that do not interfere with its primary task. Edge devices include Internet of Things devices. The appliance computing device may include hardware and software components to manage local issues such as device temperature, vibration, resource utilization, updates, power issues, physical and network security, etc. Example hardware for implementing an appliance computing device is described in conjunction with FIGS. 11-13. The Edge cloud 110 may also include one or more servers and/or one or more multi-tenant servers. Such a server may include an operating system and implement a virtual computing environment. A virtual computing environment may include a hypervisor managing (e.g., spawning, deploying, commissioning, destroying, decommissioning, etc.) one or more virtual machines, one or more containers, etc. Such virtual computing environments provide an execution environment in which one or more applications and/or other software, code, or scripts may execute while being isolated from one or more other applications, software, code, or scripts.

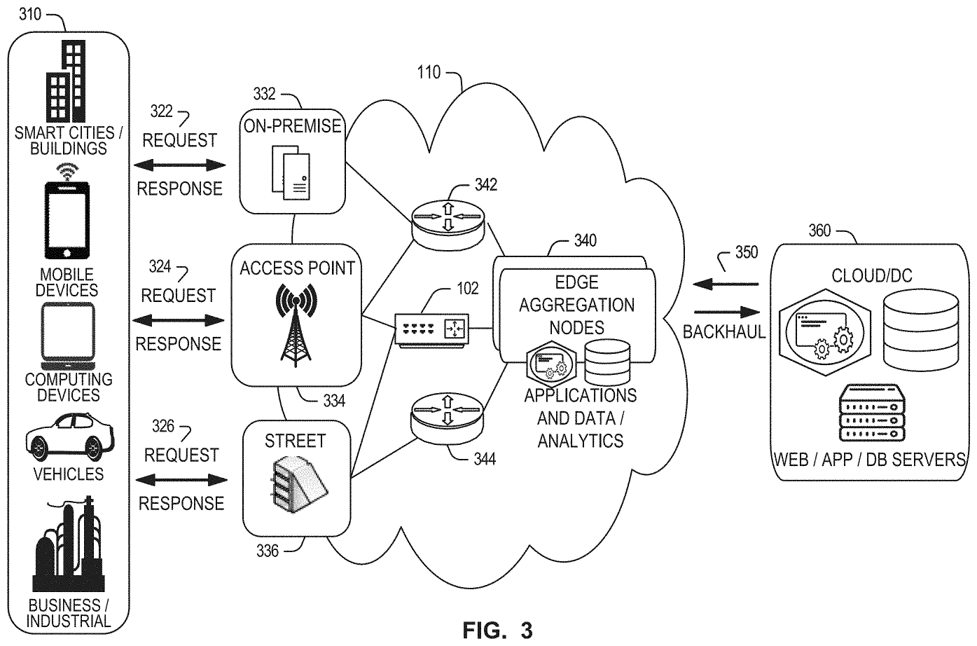

In FIG. 3, various client endpoints 310 (in the form of mobile devices, computers, autonomous vehicles, business computing equipment, industrial processing equipment) exchange requests and responses that are specific to the type of endpoint network aggregation. For instance, client endpoints 310 may obtain network access via a wired broadband network, by exchanging requests and responses 322 through an on-premise network system 332. Some client endpoints 310, such as mobile computing devices, may obtain network access via a wireless broadband network, by exchanging requests and responses 324 through an access point (e.g., a cellular network tower) 334. Some client endpoints 310, such as autonomous vehicles may obtain network access for requests and responses 326 via a wireless vehicular network through a street-located network system 336. However, regardless of the type of network access, the TSP may deploy aggregation points 342, 344 within the Edge cloud 110 to aggregate traffic and requests. Thus, within the Edge cloud 110, the TSP may deploy various compute and storage resources, such as at Edge aggregation nodes 340, to provide requested content. The Edge aggregation nodes 340 and other systems of the Edge cloud 110 are connected to a cloud or data center 360, which uses a backhaul network 350 to fulfill higher-latency requests from a cloud/data center for websites, applications, database servers, etc. Additional or consolidated instances of the Edge aggregation nodes 340, the example dynamic load balancer 102, and the aggregation points 342, 344, including those deployed on a single server framework, may also be present within the Edge cloud 110 or other areas of the TSP infrastructure.

FIG. 4 is a block diagram of the example dynamic load balancer 102 to dynamically balance deep-learning inferencing workloads for Edge devices. The dynamic load balancer 102 of FIG. 4 may be instantiated (e.g., creating an instance of, bring into being for any length of time, materialize, implement, etc.) by processor circuitry such as a central processing unit executing instructions. Additionally or alternatively, the dynamic load balancer 102 of FIG. 4 may be instantiated (e.g., creating an instance of, bring into being for any length of time, materialize, implement, etc.) by an ASIC or an FPGA structured to perform operations corresponding to the instructions. It should be understood that some or all of the circuitry of FIG. 4 may, thus, be instantiated at the same or different times. Some or all of the circuitry may be instantiated, for example, in one or more threads executing concurrently on hardware and/or in series on hardware. Moreover, in some examples, some or all of the circuitry of FIG. 4 may be implemented by microprocessor circuitry executing instructions to implement one or more virtual machines and/or containers.

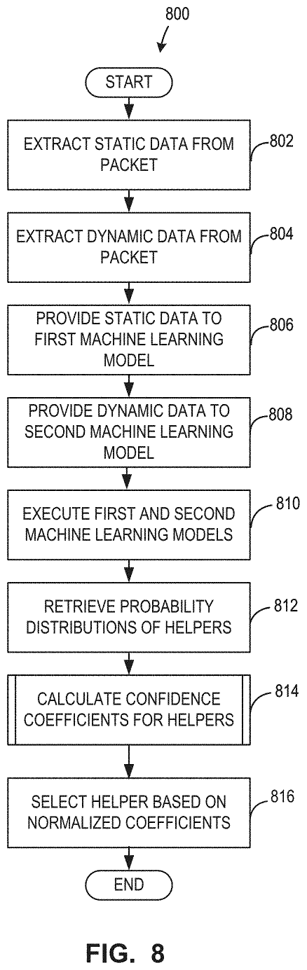

The example dynamic load balancer 102 includes example neural network circuitry 402. In some examples, the example neural network circuitry 402 is instantiated by processor circuitry executing neural network instructions and/or configured to perform operations such as those represented by the flowchart of FIGS. 8-10.

The example neural network circuitry 402 implements a plurality of bayesian deep neural networks. A first deep neural network of the plurality of bayesian deep neural networks receives a vector of static variables as input. A second bayesian deep neural network of the plurality of bayesian deep neural networks receives a vector of dynamic variables as input. The static and dynamic variables may be provided to the example neural network circuitry 402 by the example data extractor circuitry 416.

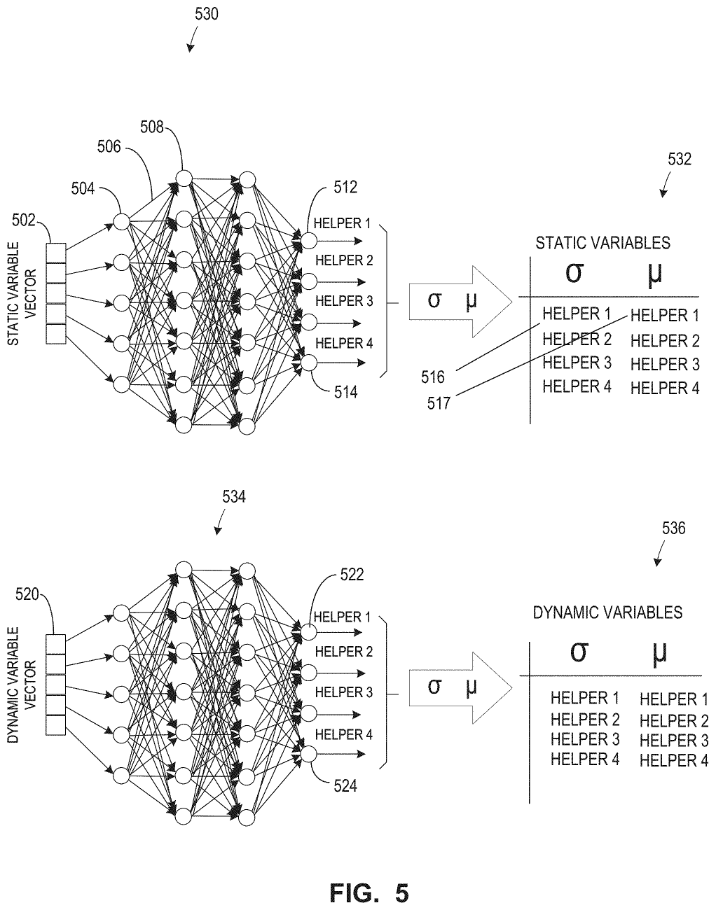

The example neural network circuitry 402 provides the example dynamic load balancer 102 the capability to generate probability distributions for a plurality of helper devices (e.g., Edge servers, Edge devices, routers). The probability distributions can be normalized by the example normalization circuitry 412 and then used to select the helper with the lowest latency, for example. An example neural network topology for the neural network circuitry 402 is described in further detail in association with FIG. 5.

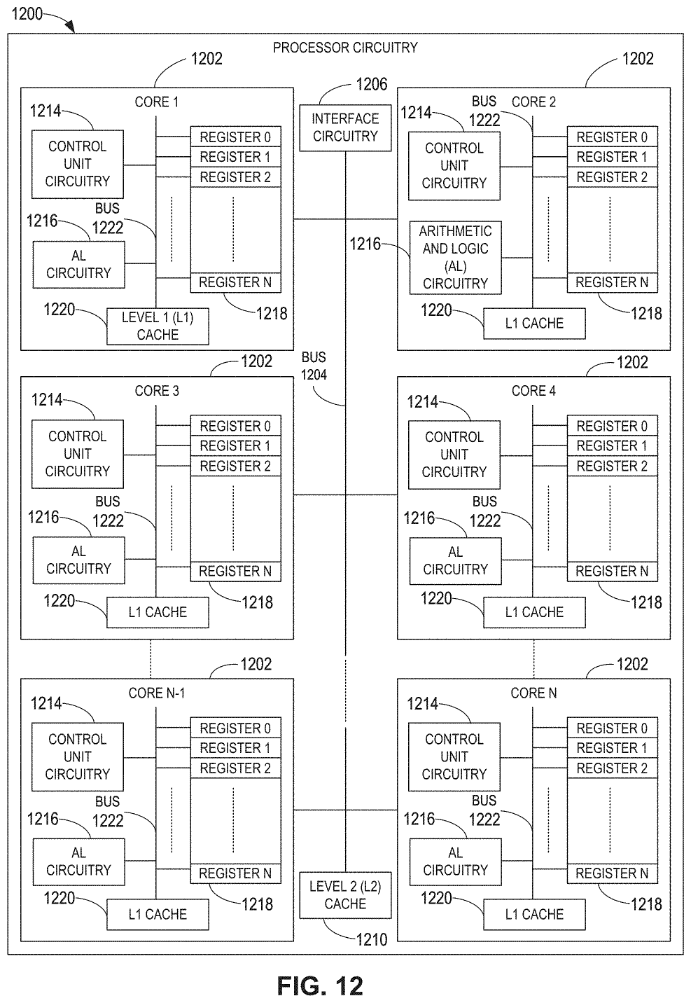

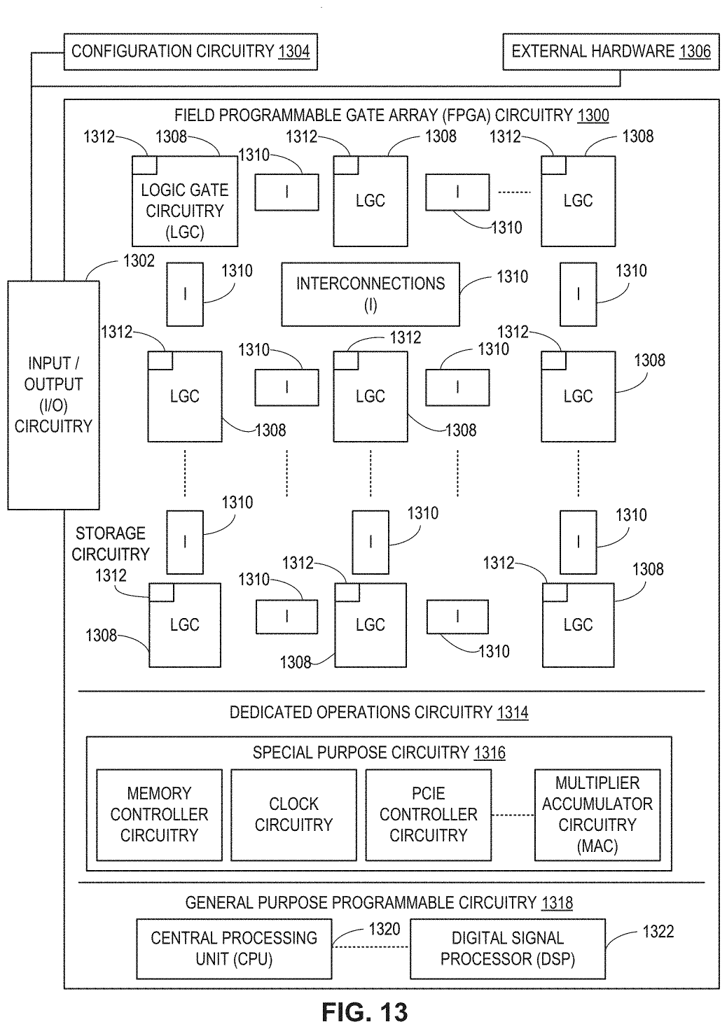

In some examples, the dynamic load balancer 102 includes means for performing inference on static and/or dynamic data. For example, the means for performing inference may be implemented by neural network circuitry 402. In some examples, the neural network circuitry 402 may be instantiated by processor circuitry such as the example processor circuitry 1112 of FIG. 11. For instance, the neural network circuitry 402 may be instantiated by the example microprocessor 1200 of FIG. 12 executing machine executable instructions such as those implemented by at least blocks 806-810 of FIG. 8. In some examples, the neural network circuitry 402 may be instantiated by hardware logic circuitry, which may be implemented by an ASIC, XPU, or the FPGA circuitry 1300 of FIG. 13 structured to perform operations corresponding to the machine readable instructions. Additionally or alternatively, the neural network circuitry 402 may be instantiated by any other combination of hardware, software, and/or firmware. For example, the neural network circuitry 402 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

The example dynamic load balancer 102 includes example probability distribution generator circuitry 404. In some examples, the example probability distribution generator circuitry 404 is instantiated by processor circuitry executing neural network instructions and/or configured to perform operations such as those represented by the flowchart of FIGS. 8-10.

The example probability distribution generator circuitry 404 is a final layer of the example neural network circuitry 402 that produces a plurality of probability distributions. In some examples, however, the neural network circuitry 402 is not a bayesian deep neural network, and therefore the output layer of the neural network circuitry 402 does not produce a probability distribution as an output. In such examples, the probability distribution generator circuitry 404 can produce a probability distribution based on previous inference results.

The example probability distribution generator circuitry 404 generates a probability distribution for each helper compute unit. The probability distribution associated with each helper node can be normalized by the example normalization circuitry 412 and used to determine a helper that can complete a request for service with the lowest possible latency.

In some examples, the dynamic load balancer 102 includes means for generating a first plurality of probability distributions. For example, the means for generating may be implemented by probability distribution generator circuitry 404. In some examples, the probability distribution generator circuitry 404 may be instantiated by processor circuitry such as the example processor circuitry 1112 of FIG. 11. For instance, the by probability distribution generator circuitry 404 may be instantiated by the example microprocessor 1200 of FIG. 12 executing machine executable instructions such as those implemented by at least blocks 806-810 of FIG. 8. In some examples, the probability distribution generator circuitry 404 may be instantiated by hardware logic circuitry, which may be implemented by an ASIC, XPU, or the FPGA circuitry 1300 of FIG. 13 structured to perform operations corresponding to the machine readable instructions. Additionally or alternatively, the probability distribution generator circuitry 404 may be instantiated by any other combination of hardware, software, and/or firmware. For example, the probability distribution generator circuitry 404 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

The example dynamic load balancer 102 includes example bayesian network circuitry 406. In some examples, the example bayesian network circuitry 406 is instantiated by processor circuitry executing bayesian network instructions and/or configured to perform operations such as those represented by the flowchart of FIGS. 8-10.

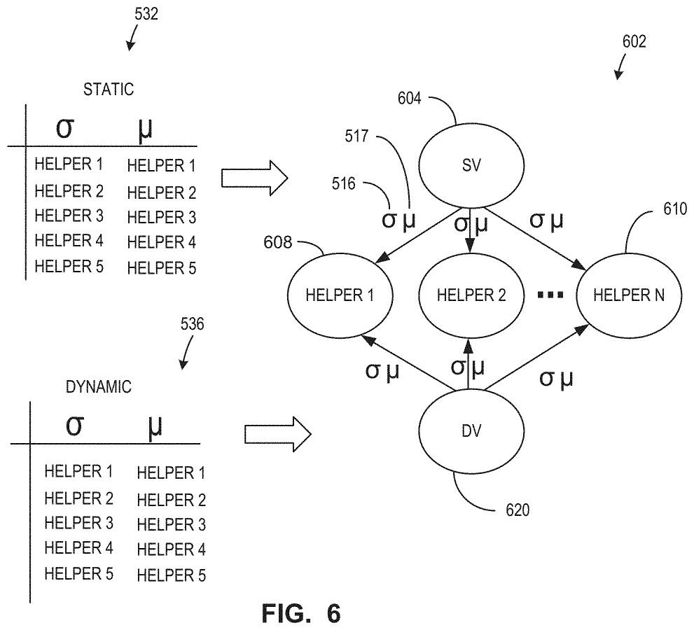

The bayesian network circuitry 406 generates a confidence model (e.g., a bayesian network). The bayesian network is a probabilistic graphical model that represents how likely each Edge compute unit of a plurality of Edge compute units is to execute a workload with the least latency. Specifically, the bayesian network circuitry 406 generates a probabilistic graph that represents the confidence values as edges of the probabilistic graph and the helper compute units as nodes of the probabilistic graph. In some examples, the bayesian network is generated from a confidence table that includes values from a plurality of helper compute units. An example bayesian network produced by the bayesian network circuitry 406 will be described in association with FIG. 6.

In some examples, the dynamic load balancer 102 includes second means for generating a probabilistic graph. For example, the second means for generating may be implemented by the example bayesian network circuitry 406. In some examples, the bayesian network circuitry 406 may be instantiated by processor circuitry such as the example processor circuitry 1112 of FIG. 11. For instance, the bayesian network circuitry 406 may be instantiated by the example microprocessor 1200 of FIG. 12 executing machine executable instructions such as those implemented by at least blocks 806-810 of FIG. 8. In some examples, bayesian network circuitry 406 may be instantiated by hardware logic circuitry, which may be implemented by an ASIC, XPU, or the FPGA circuitry 1300 of FIG. 13 structured to perform operations corresponding to the machine readable instructions. Additionally or alternatively, the bayesian network circuitry 406 may be instantiated by any other combination of hardware, software, and/or firmware. For example, the bayesian network circuitry 406 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

The example dynamic load balancer 102 includes example neural network training circuitry 408. In some examples, the neural network training circuitry 408 is instantiated by processor circuitry neural network training instructions and/or configured to perform operations such as those represented by the flowchart of FIGS. 8-10.

The example neural network training circuitry 408 trains the example neural network circuitry 402. To train the neural network circuitry 402, the example neural network training circuitry develops a training data set. In some examples, the training data set is based on output of a preexisting neural network model. For example, a non-bayesian neural network may be in operation prior to implementation of a bayesian neural network such as the deep bayesian neural networks of the example neural network circuitry 402 (e.g., as illustrated in FIG. 5). In such examples, the non-bayesian (e.g., the initial) neural network selects helper nodes and the example neural network training circuitry 408 logs data (e.g., the selected nodes, dynamic variables, static variables, latency of selected helper nodes, etc.) for a threshold period of time. The recorded data is used as a training set to optimize (e.g., via gradient descent) the bayesian neural network models.

For example, static and dynamic data from an Edge device can be logged for a threshold period. Then, inference can be performed on a first machine learning model using the static and dynamic data. An output of the inference can be logged, along with the associations between the static and/or dynamic variables and the selected helpers. The logged data can then be used as a training set that includes the static and dynamic data, indications of the selected helper compute units, and the associations.

In some examples, the dynamic load balancer 102 includes means for logging. For example, the means for logging may be implemented by the neural network training circuitry 408. In some examples, the neural network training circuitry 408 may be instantiated by processor circuitry such as the example processor circuitry 1112 of FIG. 11. For instance, the neural network training circuitry 408 may be instantiated by the example microprocessor 1200 of FIG. 12 executing machine executable instructions such as those implemented by at least blocks 806-810 of FIG. 8. In some examples, neural network training circuitry 408 may be instantiated by hardware logic circuitry, which may be implemented by an ASIC, XPU, or the FPGA circuitry 1300 of FIG. 13 structured to perform operations corresponding to the machine readable instructions. Additionally or alternatively, the neural network training circuitry 408 may be instantiated by any other combination of hardware, software, and/or firmware. For example, the neural network training circuitry 408 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

The example dynamic load balancer 102 includes example confidence calculator circuitry 410. In some examples, confidence calculator circuitry 410 is instantiated by processor circuitry executing confidence calculator instructions and/or configured to perform operations such as those represented by the flowcharts of FIGS. 8-10.

The example confidence calculator circuitry 410 calculates a confidence value for each of the helper compute units. The example confidence calculator circuitry 410 may determine a first average and a first standard deviation of a first probability distribution of a first plurality of probability distributions (e.g., generated by a first bayesian deep neural network of the neural network circuitry 402). The first plurality of probability distributions is generated based on the static variables provided by an Edge device that has requested a service.

The confidence calculator circuitry 410 can determine a second average and a second standard deviation of a first probability distribution of a second plurality of probability distributions (e.g., generated by a second bayesian neural network of the neural network circuitry 402). The example confidence calculator circuitry 410 may then add the first and second averages and subtract the first and second standard deviations to calculate a confidence coefficient.

In some examples, the confidence value is calculated from an intermediate helper confidence table. The helper confidence table may store a mean and standard deviation value for each of a plurality of helper compute units. Each confidence calculation may, for example, be calculated by performing the below operations of Equation 1:

HC1=(svMean−svSTD1)+(dvMean1−dvSTD1) Equation 1

In Equation 1, HC1 is a confidence value for helper 1. svMean is a static variable mean for helper 1, svSTD1 is a static variable standard deviation for helper 1, dvMean1 is a dynamic variable standard deviation for helper 1, and dvSTD1 is a static variable standard deviation for helper 1. Thus, in equation 1, the confidence value for helper 1 is calculated based on a single probability distribution (e.g., corresponding to a single helper compute unit) generated at an output layer of a bayesian deep neural network.

The example confidence calculator circuitry 410 generates confidence values for each helper compute unit of the plurality of helper compute units and provides these values to the normalization circuitry 412. In some examples, a helper compute unit is assigned a request for service based on having a greatest confidence value of a plurality of helper compute units.

In some examples, the dynamic load balancer 102 includes means for calculating a confidence value for a first helper compute unit of a plurality of helper compute units. For example, the means for calculating may be implemented by confidence calculator circuitry 410. In some examples, the confidence calculator circuitry 410 may be instantiated by processor circuitry such as the example processor circuitry 1112 of FIG. 11. For instance, the confidence calculator circuitry 410 may be instantiated by the example microprocessor 1200 of FIG. 12 executing machine executable instructions such as those implemented by at least blocks 806-810 of FIG. 8. In some examples, confidence calculator circuitry 410 may be instantiated by hardware logic circuitry, which may be implemented by an ASIC, XPU, or the FPGA circuitry 1300 of FIG. 13 structured to perform operations corresponding to the machine readable instructions. Additionally or alternatively, the confidence calculator circuitry 410 may be instantiated by any other combination of hardware, software, and/or firmware. For example, the confidence calculator circuitry 410 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

The example dynamic load balancer 102 includes example normalization circuitry 412. In some examples, normalization circuitry 412 is instantiated by processor circuitry executing normalization instructions and/or configured to perform operations such as those represented by the flowcharts of FIGS. 8-10.

The example normalization circuitry 412 normalizes the output of the confidence calculator circuitry 410. By normalizing the confidence values, the values for each helper compute unit can be compared and the example helper selection circuitry 414 can select the helper compute unit most likely to service the request for service with the least latency of the plurality of helper compute units. The example normalization circuitry 412 may normalize the confidence values from the helper confidence table using Equation 2 below, for example:

HCN=(HC−min(HC))/(max(HC)−min(HC)) Equation 2

In Equation 2, HCN is a normalized helper confidence value, HC is a helper confidence value, min(HC) is a minimum confidence value of the plurality of helper values, max(HC) is a maximum confidence value of the plurality of helper confidence value, min(HC) is a minimum confidence value of the plurality of confidence values. Thus, in Equation 2, a normalized confidence value is calculated for a helper compute device by subtracting the minimum helper confidence value from the instant helper confidence value and dividing by the range of helper confidence values.

In some examples, the dynamic load balancer 102 includes means for normalizing a plurality of confidence values. For example, the means for normalizing may be implemented by the example normalization circuitry 412. In some examples, the normalization circuitry 412 may be instantiated by processor circuitry such as the example processor circuitry 1112 of FIG. 11. For instance normalization circuitry 412 may be instantiated by the example microprocessor 1200 of FIG. 12 executing machine executable instructions such as those implemented by at least blocks 806-810 of FIG. 8. In some examples, normalization circuitry 412 may be instantiated by hardware logic circuitry, which may be implemented by an ASIC, XPU, or the FPGA circuitry 1300 of FIG. 13 structured to perform operations corresponding to the machine readable instructions. Additionally or alternatively, the normalization circuitry 412 may be instantiated by any other combination of hardware, software, and/or firmware. For example, the normalization circuitry 412 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

The example dynamic load balancer 102 includes example helper selection circuitry 414. In some examples, the helper selection circuitry 414 is instantiated by processor circuitry executing normalization instructions and/or configured to perform operations such as those represented by the flowcharts of FIGS. 8-10.

The example helper selection circuitry 414 selects a helper compute unit. The example helper selection circuitry 414 selects the helper with the greatest confidence value. In some examples, a helper can be selected based on the confidence value and additional characteristics (e.g., cost characteristics, permission characteristics, security characteristics, etc.).

In some examples, the dynamic load balancer 102 includes means for assigning a first helper compute unit. For example, the means for assigning may be implemented by the helper selection circuitry 414. In some examples, the helper selection circuitry 414 may be instantiated by processor circuitry such as the example processor circuitry 1112 of FIG. 11. For instance normalization circuitry 412 may be instantiated by the example microprocessor 1200 of FIG. 12 executing machine executable instructions such as those implemented by at least blocks 806-810 of FIG. 8. In some examples the helper selection circuitry 414 may be instantiated by hardware logic circuitry, which may be implemented by an ASIC, XPU, or the FPGA circuitry 1300 of FIG. 13 structured to perform operations corresponding to the machine readable instructions. Additionally or alternatively, helper selection circuitry 414 may be instantiated by any other combination of hardware, software, and/or firmware. For example, the helper selection circuitry 414 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

The example dynamic load balancer 102 includes example data extractor circuitry 416. In some examples, the data extractor circuitry 416 is instantiated by processor circuitry executing data extractor instructions and/or configured to perform operations such as those represented by the flowcharts of FIGS. 8-10.

The example data extractor circuitry 416 can parse a data packet (e.g., a request for service from a helper node) for static and dynamic data. The static and dynamic data may be further divided into static and dynamic variable vectors. The static variable vector may be provided to a first machine learning model, and the dynamic variable vector may be provided to a second machine learning model. For example, the static variable vector may be provided to a first bayesian deep neural network and the dynamic variable vector may be provided to a second bayesian deep neural network.

In some examples, an Edge device generates a request for service that is provided to the dynamic load balancer 102. The request for service may include static and dynamic variable data associated with the Edge device. In some examples, static data does not change throughout the lifetime of the Edge device. Examples of static variables include a device ID, a device type, physical device characteristics, etc. In some examples, static data may change over time (e.g., responsive to a device upgrade). Such changes to static variables and/or static data occur less frequently than changes to dynamic data. Examples of dynamic data include device location, time of day, etc., and any other data that changes more frequently than the static data.

Static and dynamic data may include additional information beyond that which is generated by the requesting Edge device. For example, static data may include data indicating infrastructure features associated with an Edge network. Dynamic data may include connection quality (e.g., latency/data throughput). Such data may significantly affect request latency and therefore may be used by the example dynamic load balancer 102 to determine a quality of the transferred data. In some examples, additional fields (e.g., beyond the static/dynamic Edge device data) may be provided to the neural network circuitry 202 for inference. Some examples may include a specification of a workload distribution protocol or a desired minimum workload execution latency.

In some examples, a data packet associated with a request for service may include data fields (e.g., parameter values, adjustable values, flags, etc.) indicating how a load balancing should occur. For example, an Edge device generating a request for service may specify that the request for service should only be provided to a specific subset of potential helper nodes. Such data fields may improve user privacy. In some examples, the adjustable data fields may be accessible by an application programming interface (API) on the edge device.

The data packets may also be encrypted. In some examples, sensitive information (e.g., device location, user identifying information) may be encrypted, obscured, and/or otherwise omitted from a data packet in a request for service. Data privacy control options may be accessible and/or adjustable via an application or a web portal associate with the edge device.

In some examples, the dynamic load balancer 102 includes means for extracting static and dynamic data from a packet. For example, the means for extracting may be implemented by the data extractor circuitry 416. In some examples, the data extractor circuitry 416 may be instantiated by processor circuitry such as the example processor circuitry 1112 of FIG. 11. For instance, data extractor circuitry 416 may be instantiated by the example microprocessor 1200 of FIG. 12 executing machine executable instructions such as those implemented by at least blocks 806-810 of FIG. 8. In some examples data extractor circuitry 416 may be instantiated by hardware logic circuitry, which may be implemented by an ASIC, XPU, or the FPGA circuitry 1300 of FIG. 13 structured to perform operations corresponding to the machine readable instructions. Additionally or alternatively, data extractor circuitry 416 may be instantiated by any other combination of hardware, software, and/or firmware. For example, the data extractor circuitry 416 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

While an example manner of implementing the dynamic load balancer 102 of FIG. 1 is illustrated in FIG. 4, one or more of the elements, processes, and/or devices illustrated in FIG. 4 may be combined, divided, re-arranged, omitted, eliminated, and/or implemented in any other way. Further, the example neural network circuitry 402, the example probability distribution generator circuitry 404, the example bayesian network circuitry 406, the example neural network training circuitry 408, the example confidence calculator circuitry 410, the example normalization circuitry 412, the example helper selection circuitry 414, the example data extractor circuitry 416, and/or, more generally, the example dynamic load balancer 102 of FIG. 4, may be implemented by hardware alone or by hardware in combination with software and/or firmware. Thus, for example, any of the example neural network circuitry 402, the example probability distribution generator circuitry 404, the example bayesian network circuitry 406, the example neural network training circuitry 408, the example confidence calculator circuitry 410, the example normalization circuitry 412, the example helper selection circuitry 414, the example data extractor circuitry 416, and/or, more generally, the example dynamic load balancer 102 of FIG. 4, could be implemented by processor circuitry, analog circuit(s), digital circuit(s), logic circuit(s), programmable processor(s), programmable microcontroller(s), graphics processing unit(s) (GPU(s)), digital signal processor(s) (DSP(s)), application specific integrated circuit(s) (ASIC(s)), programmable logic device(s) (PLD(s)), and/or field programmable logic device(s) (FPLD(s)) such as Field Programmable Gate Arrays (FPGAs). Further still, the example dynamic load balancer 102 of FIGS. 1-4 may include one or more elements, processes, and/or devices in addition to, or instead of, those illustrated in FIG. 4, and/or may include more than one of any or all of the illustrated elements, processes and devices.

FIG. 5 is an illustration of example first neural network circuitry 530, example second neural network circuitry 534, example first confidence table 532, and example second confidence table 536.

The example first neural network circuitry 530 is a first bayesian deep neural network. Bayesian neural networks combine the weights and biases of neural networks with Bayesian inference, quantifying uncertainty by generating probability distributions at their outputs.

The example first neural network circuitry 530 takes a static variable vector 502 as input. A portion of the static variable vector 502 is provided to an example first neuron 504. The example first neuron 504 is connected to the example second neuron 508 by a first synapse 506. The example first neuron 504 performs an operation on the input based on an activation function, a weight distribution, and a bias distribution. In some examples, the activation function uses a sample of one weight of the weight distribution and one bias of the bias distribution to determine an activation.

The first output node 512 produces a probability distribution representing a likelihood that a first helper compute unit (e.g., helper 1), can execute a workload associated with a request for service with the least latency. For example, the first output node 512 may generate a set of five probabilities for the static input vector 502. Similarly, the example second output node 514 may generate another set of five probabilities representing a likelihood that a fourth helper compute unit (e.g., helper 4) can perform a requested task with the least latency.

The example second neural network circuitry 534 (e.g., also a bayesian deep neural network) takes the dynamic variable vector 520 as input, producing the third probability distribution 522 (e.g., corresponding to helper 1) and the fourth probability distribution 524 (e.g., corresponding to helper 4) as outputs. However, in some examples a single model is used that takes both static and dynamic variable vectors as input.

The example first confidence table 532 includes means and standard deviations for each of the helpers associated with output nodes of the first bayesian deep neural network 530. An example first standard deviation 516 and a first mean 517 correspond to the first output node 512 (e.g., mean and standard deviation of a probability distribution generated by the first output node 512).

The standard deviation can be interpreted as uncertainty in helper compute unit selection, while the mean can be interpreted as certainty in helper compute unit selection. In some examples, the first and second confidence tables 532 and 536 could instead be a graph, a table or any suitable data structure.

FIG. 6 includes the first confidence table 532 and the second confidence table 536 of FIG. 5. The example bayesian network circuitry 406 generates a confidence graph (e.g., a bayesian network) based on the confidence tables. The example bayesian network 602 is a probabilistic graphical model that illustrates and quantifies the uncertainty associated with helper compute unit selection. The first node 604 is connected to the first helper 608 by an edge that represents a confidence value. In some examples, the confidence tables 532 and 536 and the bayesian network 602 are displayed via a graphical user interface to provide a user better understanding of the neural network decision process. Alternatively, the confidence tables 532 and 536 and the bayesian graph 602 may be omitted and the helper compute unit selected based on a direct calculation (e.g., Equations 1 and 2 above using the output of the first and second bayesian neural networks).

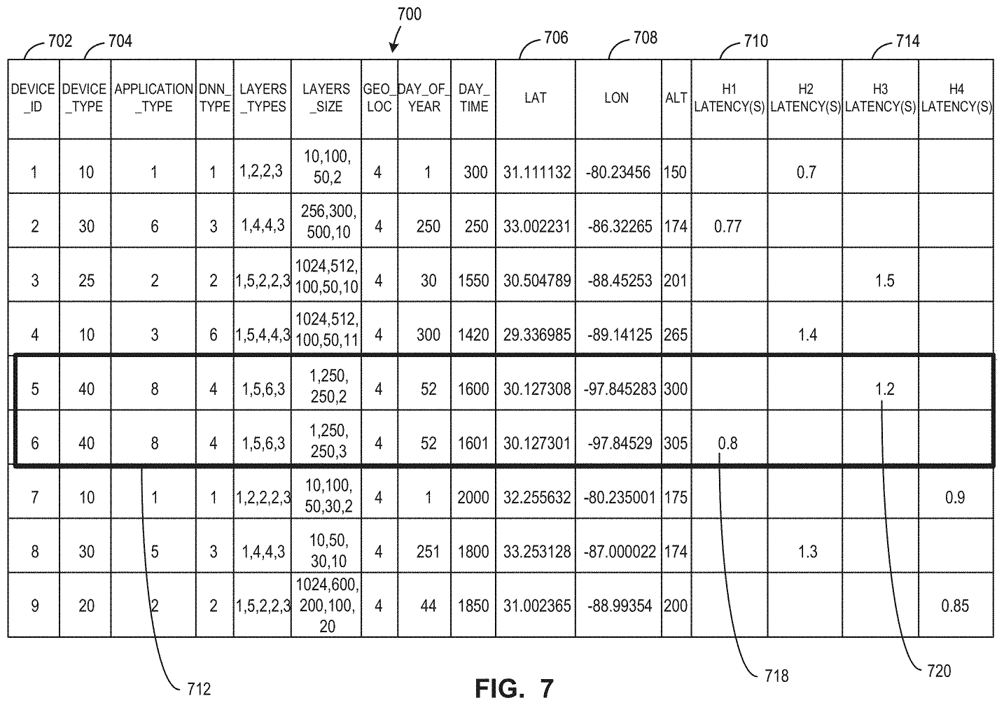

FIG. 7 is an example table 700 that of data stored by the example neural network training circuitry 408 (e.g., that trains the neural network circuitry 402 of FIG. 4) can use to log events and make training set selections. Columns 702 and 704 are examples of static variables. For example, device_ID and device type may remain static throughout the lifetime of a device. Columns 706 and 708 are examples of dynamic variables. The dynamic variables such as location (e.g., GEO_LOC, LAT, LON) and timestamp data (e.g., DAY_TIME) change more frequently than static variables. The table 700 also includes columns 710 and 714, which indicate the how long helper compute units took to complete each request for service.

For example, the value 718 is an example latency for a workload execution requested by DEVICE_ID 6. The value 720 is an example latency for a workload execution requested by DEVICE_ID 5. DEVICE_ID 6 and DEVICE_ID 5 have similar GEO_LOC, DAY_TIME, LAT, and LON values. As the H1 latency was shorter for these similar workloads, it was selected by the preexisting non-bayesian neural network. These data can be used as a part of a training data set to train the example bayesian neural networks of the dynamic load balancer 102 of FIG. 2.

Flowcharts representative of example machine readable instructions, which may be executed to configure processor circuitry to implement the dynamic load balancer of FIGS. 1-4 is shown in FIGS. 8-10. The machine readable instructions may be one or more executable programs or portion(s) of an executable program for execution by processor circuitry, such as the processor circuitry 1112 shown in the example processor platform 1100 discussed below in connection with FIG. 11 and/or the example processor circuitry discussed below in connection with FIGS. 12 and/or 13. The program may be embodied in software stored on one or more non-transitory computer readable storage media such as a compact disk (CD), a floppy disk, a hard disk drive (HDD), a solid-state drive (SSD), a digital versatile disk (DVD), a Blu-ray disk, a volatile memory (e.g., Random Access Memory (RAM) of any type, etc.), or a non-volatile memory (e.g., electrically erasable programmable read-only memory (EEPROM), FLASH memory, an HDD, an SSD, etc.) associated with processor circuitry located in one or more hardware devices, but the entire program and/or parts thereof could alternatively be executed by one or more hardware devices other than the processor circuitry and/or embodied in firmware or dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a user) or an intermediate client hardware device (e.g., a radio access network (RAN)) gateway that may facilitate communication between a server and an endpoint client hardware device). Similarly, the non-transitory computer readable storage media may include one or more mediums located in one or more hardware devices. Further, although the example program is described with reference to the flowchart illustrated in FIGS. 8-10, many other methods of implementing the example dynamic load balancer 102 may alternatively be used. For example, the order of execution of the blocks may be changed, and/or some of the blocks described may be changed, eliminated, or combined. Additionally or alternatively, any or all of the blocks may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more hardware devices (e.g., a single-core processor (e.g., a single core central processor unit (CPU)), a multi-core processor (e.g., a multi-core CPU, an XPU, etc.) in a single machine, multiple processors distributed across multiple servers of a server rack, multiple processors distributed across one or more server racks, a CPU and/or a FPGA located in the same package (e.g., the same integrated circuit (IC) package or in two or more separate housings, etc.).

The machine readable instructions described herein may be stored in one or more of a compressed format, an encrypted format, a fragmented format, a compiled format, an executable format, a packaged format, etc. Machine readable instructions as described herein may be stored as data or a data structure (e.g., as portions of instructions, code, representations of code, etc.) that may be utilized to create, manufacture, and/or produce machine executable instructions. For example, the machine readable instructions may be fragmented and stored on one or more storage devices and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of machine executable instructions that implement one or more operations that may together form a program such as that described herein.

In another example, the machine readable instructions may be stored in a state in which they may be read by processor circuitry, but require addition of a library (e.g., a dynamic link library (DLL)), a software development kit (SDK), an application programming interface (API), etc., in order to execute the machine readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable media, as used herein, may include machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 8-10 may be implemented using executable instructions (e.g., computer and/or machine readable instructions) stored on one or more non-transitory computer and/or machine readable media such as optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms non-transitory computer readable medium, non-transitory computer readable storage medium, non-transitory machine readable medium, and non-transitory machine readable storage medium are expressly defined to include any type of computer readable storage device and/or storage disk and to exclude propagating signals and to exclude transmission media. As used herein, the terms “computer readable storage device” and “machine readable storage device” are defined to include any physical (mechanical and/or electrical) structure to store information, but to exclude propagating signals and to exclude transmission media. Examples of computer readable storage devices and machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer readable instructions, machine readable instructions, etc.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements or method actions may be implemented by, e.g., the same entity or object. Additionally, although individual features may be included in different examples or claims, these may possibly be combined, and the inclusion in different examples or claims does not imply that a combination of features is not feasible and/or advantageous.

FIG. 8 is a flowchart representative of example machine readable instructions and/or example operations 800 that may be executed and/or instantiated by processor circuitry to perform dynamic load balancing of machine learning workloads at the Edge. The machine readable instructions and/or the operations 800 of FIG. 8 begin at block 802, at which the data extractor circuitry 416 of FIG. 4 extracts static data from a packet. For example, an Edge device may determine it is unable to meet a performance threshold (e.g., power threshold, latency threshold, etc.) and send a request for service to the dynamic load balancer 102 of FIG. 4. The dynamic load balancer 102 of FIG. 2 may receive the request for service and extract a device identifier, a device type, and an application type from the request for service.

At block 804, the example data extractor circuitry 416 of FIG. 4 extracts dynamic data from the request for service. For example, the data extractor circuitry may extract (e.g., parse from a data packet) dynamic data including a geographic location and a data timestamp from the packet.

At block 806, the example neural network circuitry 402 of FIG. 4 provides the static data to a first machine learning model. The example first machine learning model is instantiated by the example neural network circuitry 402 of FIG. 4 and is a bayesian neural network model that is distinct from a second machine learning model that processes dynamic variable data. The parsed static data may undergo a preprocessing phase in which the data is vectorized and/or otherwise reformatted (e.g., redundant data removed, data reordered, etc.) before being provided to the example first bayesian deep neural network.

At block 808, the example neural network circuitry provides dynamic data to a second machine learning model. The example second machine learning model is instantiated by the example neural network circuitry 402 of FIG. 4 and is a bayesian neural network model that is distinct from the first machine learning model that processes dynamic variable data. The parsed dynamic data may undergo a preprocessing phase in which the data is vectorized and/or otherwise reformatted (e.g., remove redundant data, order data, etc.) before being provided to the example second bayesian deep neural network. In some examples, the first and second deep neural network models may instead be a single deep neural network model that performs inference on static and dynamic data with a single machine learning model. Additionally, or alternatively, machine learning models that are not neural networks may be used to develop a probability distribution.

At block 810, the example neural network circuitry 402 executes first and second machine learning models. The first and second machine learning models are bayesian machine learning models that quantify the uncertainty associated with helper compute unit selection. The example first and second machine learning models take the static and dynamic data as their input. Each model produces a probability distribution for each potential helper compute unit at its output, which is retrieved by the example confidence calculator circuitry 410 of FIG. 4 at block 812.

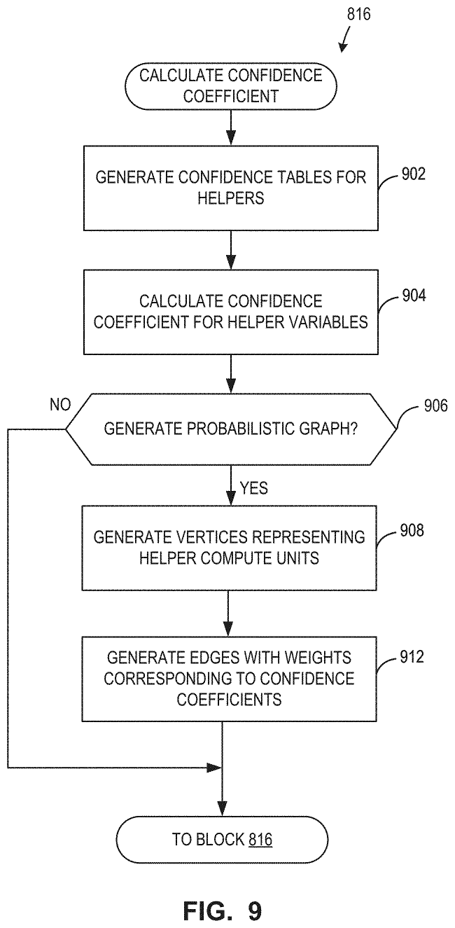

At block 814, the example confidence calculator circuitry 410 calculates a confidence coefficient for the helpers. For example, the confidence coefficient may be calculated and normalized based on the above Equations 1 and 2. The instructions of block 814 will be further described in association with FIG. 9.

At block 816 the example helper selection circuitry 414 selects a helper compute unit based on normalized coefficients. The helper compute unit may select a helper unit based on the confidence coefficients for each helper compute unit. For example, the greatest confidence coefficient may be selected as the helper compute unit that is most likely to meet a threshold performance objective such as execution latency. The instructions 800 end. In some examples, additional iterations of the instructions 800 may be triggered. For example, if the dynamic load balancer 102 receives an additional packet including static and/or dynamic data, the instructions 1000 may execute again.

FIG. 9 is a flowchart representative of example machine readable instructions and/or example operations 816 that may be executed and/or instantiated by processor circuitry to calculate a confidence coefficient. The machine readable instructions and/or the operations 816 of FIG. 9 begin at block 902, at which the example confidence calculator circuitry 410 of FIG. 4 generates confidence tables for helpers. The example confidence table may store standard deviation and mean values of probability distributions generated by the example probability distribution generator circuitry 404 of FIG. 4. The confidence calculator circuitry 410 of FIG. 4 uses the mean and standard deviation values from the confidence table in calculating and normalizing the confidence coefficient values.

At block 904, the example confidence calculator circuitry 410 of FIG. 4 calculates confidence coefficients for helper variables. For example, the confidence calculator circuitry 410 of FIG. 4 may calculate the confidence coefficients based on Equation 1 above. The example confidence calculator circuitry 410 may then normalize the confidence coefficient values to allow for comparison of the values and facilitate selection of the helper compute unit by the example helper selection circuitry 414.

At block 906, the example confidence calculator circuitry 410 determines if a probabilistic graph is to be generated. The example dynamic load balancer 102 of FIG. 2 can generate a bayesian network to calculate and/or otherwise visualize the helper node decision. However, in some examples, a dynamic load balancer may not generate a probabilistic graph, and may instead select a helper directly based on the results of Equations 1 and/or 2 above.

If, however, a probabilistic graph is to be generated, instructions continue at block 908 at which the example bayesian network circuitry 406 generates vertices representing helper compute units. At block 912, the example bayesian network circuitry 406 connects the vertices with weighted edges that represent a confidence that a helper compute unit can achieve a performance requirement. Each helper compute unit therefore may have a connection to a first node representing the static variable confidence and a second node representing the dynamic variables, as illustrated by the example bayesian network 602 of FIG. 6.

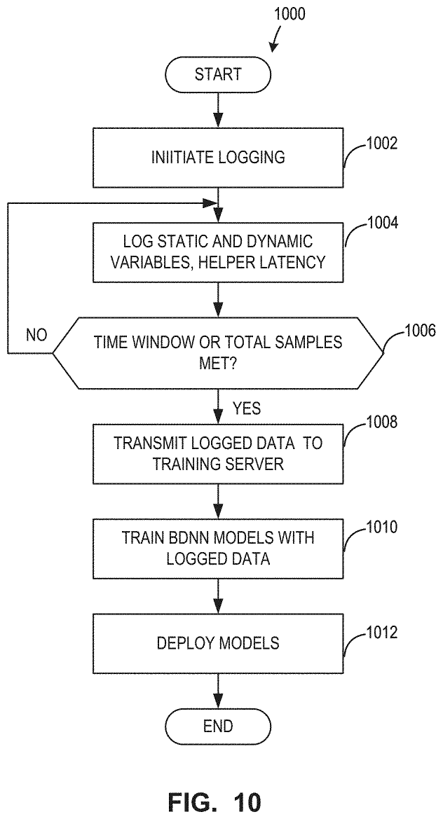

FIG. 10 is a flowchart representative of example machine readable instructions and/or example operations 816 that may be executed and/or instantiated by processor circuitry to train an example bayesian neural network of the example dynamic load balancer 102 of FIG. 2. The machine readable instructions and/or the operations 1000 of FIG. 10 start at block 1002 at which the example neural network training circuitry 408 initiates logging. The example dynamic load balancer 102 of FIG. 2 starts with a preexisting (e.g., a non-bayesian) load balancing model. Data provided to, and generated by, the preexisting model is used to train the bayesian deep neural network of the dynamic load balancer 102 of FIG. 2.

At block 1004, the example neural network training circuitry 408 of FIG. 4 collects and groups static and dynamic variable data. For example, the neural network training circuitry 408 of FIG. 4 may define parameters such as a time period (e.g., seconds, minutes, days), a geographic area (e.g., square meters, square kilometers, etc.), a specific application type, or a neural network type and collect data associated with the parameters. The example neural network training circuitry 408 of FIG. 4 also logs the results of inference by the preexisting model and associations between the input data (e.g., the static and dynamic data) and the output selected by the preexisting model.

At block 1006, the example neural network training circuitry 408 of FIG. 4 determines if a data collection threshold has been met. For example, the neural network training circuitry 408 of FIG. 4 may determine a training data collection time period has expired or a threshold number of total samples are met. If so, at block 1008 the example neural network training circuitry 408 transmits logged data to a training server. In some examples, the training server is an Edge resource that can train the bayesian neural network of the example dynamic load balancer 102 of FIG. 2. In other examples, the training is conducted in the cloud.

At block 1010 the example neural network training circuitry 408 trains a bayesian deep neural network model with the logged data. For example, the neural network training circuitry 408 may split the logged data into test and training sets. The example neural network circuitry 402 includes bayesian neural networks, so, instead of learning specific weight and values, the neural network circuitry 402 learns distributions that encode system uncertainty.

At block 1012, the example dynamic load balancer 102 of FIG. 4 deploys the two trained bayesian neural networks. In some examples, a preexisting model is first deactivated and then the two bayesian machine learning models are activated. The instructions 1000 end.

In some examples, additional iterations of the instructions 1000 may be triggered. For example, if input data distributions have deviated significantly from that of the original training set, the instructions 1000 may execute again. In general, additional iterations of the instructions 1000 may execute whenever the training server determines additional training data may improve model accuracy.

FIG. 11 is a block diagram of an example processor platform 1100 structured to execute and/or instantiate the machine readable instructions and/or the operations of FIGS. 8-10 to implement the example dynamic load balancer 102 of FIGS. 1-4. The processor platform 1100 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing device.

The processor platform 1100 of the illustrated example includes processor circuitry 1112. The processor circuitry 1112 of the illustrated example is hardware. For example, the processor circuitry 1112 can be implemented by one or more integrated circuits, logic circuits, FPGAs, microprocessors, CPUs, GPUs, DSPs, and/or microcontrollers from any desired family or manufacturer. The processor circuitry 1112 may be implemented by one or more semiconductor based (e.g., silicon based) devices. In this example, the processor circuitry 1112 implements the example neural network circuitry 402, the example probability distribution generator circuitry 404, the example bayesian network circuitry 406, the example neural network training circuitry 408, the example confidence calculator circuitry 410, the example normalization circuitry 412, the example helper selection circuitry 414, and the example data extractor circuitry 416.

The processor circuitry 1112 of the illustrated example includes a local memory 1113 (e.g., a cache, registers, etc.). The processor circuitry 1112 of the illustrated example is in communication with a main memory including a volatile memory 1114 and a non-volatile memory 1116 by a bus 1118. The volatile memory 1114 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1116 may be implemented by flash memory and/or any other desired type of memory device. Access to the main memory 1114, 1116 of the illustrated example is controlled by a memory controller 1117.

The processor platform 1100 of the illustrated example also includes interface circuitry 1120. The interface circuitry 1120 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 1122 are connected to the interface circuitry 1120. The input device(s) 1122 permit(s) a user to enter data and/or commands into the processor circuitry 1112. The input device(s) 1122 can be implemented by, for example, an audio sensor, a microphone, a camera (still or video), a keyboard, a button, a mouse, a touchscreen, a track-pad, a trackball, an isopoint device, and/or a voice recognition system.

One or more output devices 1124 are also connected to the interface circuitry 1120 of the illustrated example. The output device(s) 1124 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 1120 of the illustrated example, thus, typically includes a graphics driver card, a graphics driver chip, and/or graphics processor circuitry such as a GPU.

The interface circuitry 1120 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1126. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The processor platform 1100 of the illustrated example also includes one or more mass storage devices 1128 to store software and/or data. Examples of such mass storage devices 1128 include magnetic storage devices, optical storage devices, floppy disk drives, HDDs, CDs, Blu-ray disk drives, redundant array of independent disks (RAID) systems, solid state storage devices such as flash memory devices and/or SSDs, and DVD drives.

The machine readable instructions 1132, which may be implemented by the machine readable instructions of FIGS. 8-10, may be stored in the mass storage device 1128, in the volatile memory 1114, in the non-volatile memory 1116, and/or on a removable non-transitory computer readable storage medium such as a CD or DVD.

FIG. 12 is a block diagram of an example implementation of the processor circuitry 1112 of FIG. 11. In this example, the processor circuitry 1112 of FIG. 11 is implemented by a microprocessor 1200. For example, the microprocessor 1200 may be a general purpose microprocessor (e.g., general purpose microprocessor circuitry). The microprocessor 1200 executes some or all of the machine readable instructions of the flowcharts of FIGS. 8-10 to effectively instantiate the dynamic load balancer 102 of FIGS. 1-4 as logic circuits to perform the operations corresponding to those machine readable instructions. In some such examples, the dynamic load balancer 102 of FIGS. 1-4 is instantiated by the hardware circuits of the microprocessor 1200 in combination with the instructions. For example, the microprocessor 1200 may be implemented by multi-core hardware circuitry such as a CPU, a DSP, a GPU, an XPU, etc. Although it may include any number of example cores 1202 (e.g., 1 core), the microprocessor 1200 of this example is a multi-core semiconductor device including N cores. The cores 1202 of the microprocessor 1200 may operate independently or may cooperate to execute machine readable instructions. For example, machine code corresponding to a firmware program, an embedded software program, or a software program may be executed by one of the cores 1202 or may be executed by multiple ones of the cores 1202 at the same or different times. In some examples, the machine code corresponding to the firmware program, the embedded software program, or the software program is split into threads and executed in parallel by two or more of the cores 1202. The software program may correspond to a portion or all of the machine readable instructions and/or operations represented by the flowchart of FIGS. 8-10.

The cores 1202 may communicate by a first example bus 1204. In some examples, the first bus 1204 may be implemented by a communication bus to effectuate communication associated with one(s) of the cores 1202. For example, the first bus 1204 may be implemented by at least one of an Inter-Integrated Circuit (I2C) bus, a Serial Peripheral Interface (SPI) bus, a PCI bus, or a PCIe bus. Additionally or alternatively, the first bus 1204 may be implemented by any other type of computing or electrical bus. The cores 1202 may obtain data, instructions, and/or signals from one or more external devices by example interface circuitry 1206. The cores 1202 may output data, instructions, and/or signals to the one or more external devices by the interface circuitry 1206. Although the cores 1202 of this example include example local memory 1220 (e.g., Level 1 (L1) cache that may be split into an L1 data cache and an L1 instruction cache), the microprocessor 1200 also includes example shared memory 1210 that may be shared by the cores (e.g., Level 2 (L2 cache)) for high-speed access to data and/or instructions. Data and/or instructions may be transferred (e.g., shared) by writing to and/or reading from the shared memory 1210. The local memory 1220 of each of the cores 1202 and the shared memory 1210 may be part of a hierarchy of storage devices including multiple levels of cache memory and the main memory (e.g., the main memory 1114, 1116 of FIG. 11). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1202 may be referred to as a CPU, DSP, GPU, etc., or any other type of hardware circuitry. Each core 1202 includes control unit circuitry 1214, arithmetic and logic (AL) circuitry (sometimes referred to as an ALU) 1216, a plurality of registers 1218, the local memory 1220, and a second example bus 1222. Other structures may be present. For example, each core 1202 may include vector unit circuitry, single instruction multiple data (SIMD) unit circuitry, load/store unit (LSU) circuitry, branch/jump unit circuitry, floating-point unit (FPU) circuitry, etc. The control unit circuitry 1214 includes semiconductor-based circuits structured to control (e.g., coordinate) data movement within the corresponding core 1202. The AL circuitry 1216 includes semiconductor-based circuits structured to perform one or more mathematic and/or logic operations on the data within the corresponding core 1202. The AL circuitry 1216 of some examples performs integer based operations. In other examples, the AL circuitry 1216 also performs floating point operations. In yet other examples, the AL circuitry 1216 may include first AL circuitry that performs integer based operations and second AL circuitry that performs floating point operations. In some examples, the AL circuitry 1216 may be referred to as an Arithmetic Logic Unit (ALU). The registers 1218 are semiconductor-based structures to store data and/or instructions such as results of one or more of the operations performed by the AL circuitry 1216 of the corresponding core 1202. For example, the registers 1218 may include vector register(s), SIMD register(s), general purpose register(s), flag register(s), segment register(s), machine specific register(s), instruction pointer register(s), control register(s), debug register(s), memory management register(s), machine check register(s), etc. The registers 1218 may be arranged in a bank as shown in FIG. 12. Alternatively, the registers 1218 may be organized in any other arrangement, format, or structure including distributed throughout the core 1202 to shorten access time. The second bus 1222 may be implemented by at least one of an I2C bus, a SPI bus, a PCI bus, or a PCIe bus

Each core 1202 and/or, more generally, the microprocessor 1200 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1200 is a semiconductor device fabricated to include many transistors interconnected to implement the structures described above in one or more integrated circuits (ICs) contained in one or more packages. The processor circuitry may include and/or cooperate with one or more accelerators. In some examples, accelerators are implemented by logic circuitry to perform certain tasks more quickly and/or efficiently than can be done by a general purpose processor. Examples of accelerators include ASICs and FPGAs such as those discussed herein. A GPU or other programmable device can also be an accelerator. Accelerators may be on-board the processor circuitry, in the same chip package as the processor circuitry and/or in one or more separate packages from the processor circuitry.

FIG. 13 is a block diagram of another example implementation of the processor circuitry 1112 of FIG. 4. In this example, the processor circuitry 1112 is implemented by FPGA circuitry 1300. For example, the FPGA circuitry 1300 may be implemented by an FPGA. The FPGA circuitry 1300 can be used, for example, to perform operations that could otherwise be performed by the example microprocessor 1200 of FIG. 12 executing corresponding machine readable instructions. However, once configured, the FPGA circuitry 1300 instantiates the machine readable instructions in hardware and, thus, can often execute the operations faster than they could be performed by a general purpose microprocessor executing the corresponding software.

More specifically, in contrast to the microprocessor 1200 of FIG. 12 described above (which is a general purpose device that may be programmed to execute some or all of the machine readable instructions represented by the flowcharts of FIGS. 8-10 but whose interconnections and logic circuitry are fixed once fabricated), the FPGA circuitry 1300 of the example of FIG. 13 includes interconnections and logic circuitry that may be configured and/or interconnected in different ways after fabrication to instantiate, for example, some or all of the machine readable instructions represented by the flowchart of FIGS. 8-10. In particular, the FPGA circuitry 1300 may be thought of as an array of logic gates, interconnections, and switches. The switches can be programmed to change how the logic gates are interconnected by the interconnections, effectively forming one or more dedicated logic circuits (unless and until the FPGA circuitry 1300 is reprogrammed). The configured logic circuits enable the logic gates to cooperate in different ways to perform different operations on data received by input circuitry. Those operations may correspond to some or all of the software represented by the flowchart of FIGS. 8-10. As such, the FPGA circuitry 1300 may be structured to effectively instantiate some or all of the machine readable instructions of the flowchart of FIGS. 8-10 as dedicated logic circuits to perform the operations corresponding to those software instructions in a dedicated manner analogous to an ASIC. Therefore, the FPGA circuitry 1300 may perform the operations corresponding to the some or all of the machine readable instructions of FIGS. 8 10 faster than the general purpose microprocessor can execute the same.

In the example of FIG. 13, the FPGA circuitry 1300 is structured to be programmed (and/or reprogrammed one or more times) by an end user by a hardware description language (HDL) such as Verilog. The FPGA circuitry 1300 of FIG. 13, includes example input/output (I/O) circuitry 1302 to obtain and/or output data to/from example configuration circuitry 1304 and/or external hardware 1306. For example, the configuration circuitry 1304 may be implemented by interface circuitry that may obtain machine readable instructions to configure the FPGA circuitry 1300, or portion(s) thereof. In some such examples, the configuration circuitry 1304 may obtain the machine readable instructions from a user, a machine (e.g., hardware circuitry (e.g., programmed or dedicated circuitry) that may implement an Artificial Intelligence/Machine Learning (AI/ML) model to generate the instructions), etc. In some examples, the external hardware 1306 may be implemented by external hardware circuitry. For example, the external hardware 1306 may be implemented by the microprocessor 1200 of FIG. 12. The FPGA circuitry 1300 also includes an array of example logic gate circuitry 1308, a plurality of example configurable interconnections 1310, and example storage circuitry 1312. The logic gate circuitry 1308 and the configurable interconnections 1310 are configurable to instantiate one or more operations that may correspond to at least some of the machine readable instructions of FIGS. 8-10 and/or other desired operations. The logic gate circuitry 1308 shown in FIG. 13 is fabricated in groups or blocks. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1308 to enable configuration of the electrical structures and/or the logic gates to form circuits to perform desired operations. The logic gate circuitry 1308 may include other electrical structures such as look-up tables (LUTs), registers (e.g., flip-flops or latches), multiplexers, etc.

The configurable interconnections 1310 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1308 to program desired logic circuits.

The storage circuitry 1312 of the illustrated example is structured to store result(s) of the one or more of the operations performed by corresponding logic gates. The storage circuitry 1312 may be implemented by registers or the like. In the illustrated example, the storage circuitry 1312 is distributed amongst the logic gate circuitry 1308 to facilitate access and increase execution speed.

The example FPGA circuitry 1300 of FIG. 13 also includes example Dedicated Operations Circuitry 1314. In this example, the Dedicated Operations Circuitry 1314 includes special purpose circuitry 1316 that may be invoked to implement commonly used functions to avoid the need to program those functions in the field. Examples of such special purpose circuitry 1316 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1300 may also include example general purpose programmable circuitry 1318 such as an example CPU 1320 and/or an example DSP 1322. Other general purpose programmable circuitry 1318 may additionally or alternatively be present such as a GPU, an XPU, etc., that can be programmed to perform other operations.

Although FIGS. 12 and 13 illustrate two example implementations of the processor circuitry 1112 of FIG. 11, many other approaches are contemplated. For example, as mentioned above, modern FPGA circuitry may include an on-board CPU, such as one or more of the example CPU 1320 of FIG. 13. Therefore, the processor circuitry 1112 of FIG. 11 may additionally be implemented by combining the example microprocessor 1200 of FIG. 12 and the example FPGA circuitry 1300 of FIG. 13. In some such hybrid examples, a first portion of the machine readable instructions represented by the flowcharts of FIGS. 8-10 may be executed by one or more of the cores 1202 of FIG. 12, a second portion of the machine readable instructions represented by the flowcharts of FIGS. 8-10 may be executed by the FPGA circuitry 1300 of FIG. 13, and/or a third portion of the machine readable instructions represented by the flowcharts of FIGS. 8-10 may be executed by an ASIC. It should be understood that some or all of the circuitry of FIG. 4 may, thus, be instantiated at the same or different times. Some or all of the circuitry may be instantiated, for example, in one or more threads executing concurrently and/or in series. Moreover, in some examples, some or all of the circuitry of FIG. 4 may be implemented within one or more virtual machines and/or containers executing on the microprocessor.

In some examples, the processor circuitry 1112 of FIG. 11 may be in one or more packages. For example, the microprocessor 1200 of FIG. 12 and/or the FPGA circuitry 1300 of FIG. 13 may be in one or more packages. In some examples, an XPU may be implemented by the processor circuitry 1112 of FIG. 11, which may be in one or more packages. For example, the XPU may include a CPU in one package, a DSP in another package, a GPU in yet another package, and an FPGA in still yet another package.

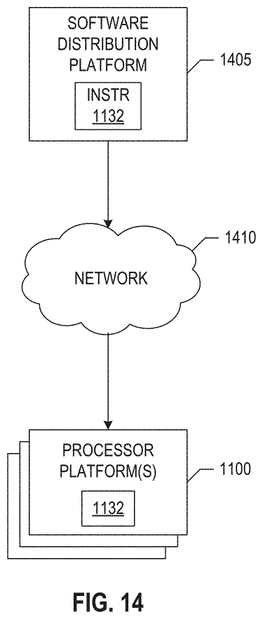

A block diagram illustrating an example software distribution platform 1405 to distribute software such as the example machine readable instructions 1132 of FIG. 11 to hardware devices owned and/or operated by third parties is illustrated in FIG. 14. The example software distribution platform 1405 may be implemented by any computer server, data facility, cloud service, etc., capable of storing and transmitting software to other computing devices. The third parties may be customers of the entity owning and/or operating the software distribution platform 1405. For example, the entity that owns and/or operates the software distribution platform 1405 may be a developer, a seller, and/or a licensor of software such as the example machine readable instructions 1132 of FIG. 11. The third parties may be consumers, users, retailers, OEMs, etc., who purchase and/or license the software for use and/or re-sale and/or sub-licensing. In the illustrated example, the software distribution platform 1405 includes one or more servers and one or more storage devices. The storage devices store the machine readable instructions 1132, which may correspond to the example machine readable instructions 800 and 1000 of FIGS. 8-10, as described above. The one or more servers of the example software distribution platform 1405 are in communication with an example network 1410, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 1132 from the software distribution platform 1405. For example, the software, which may correspond to the example machine readable instructions 800 and 1000 of FIGS. 8-10, may be downloaded to the example processor platform 400, which is to execute the machine readable instructions 1132 to implement the dynamic load balancer 102 of FIG. 4. In some examples, one or more servers of the software distribution platform 1405 periodically offer, transmit, and/or force updates to the software (e.g., the example machine readable instructions 1132 of FIG. 11) to ensure improvements, patches, updates, etc., are distributed and applied to the software at the end user devices.

From the foregoing, it will be appreciated that example systems, methods, apparatus, and articles of manufacture have been disclosed that dynamically load balance machine learning workloads at the Edge. Disclosed systems, methods, apparatus, and articles of manufacture improve the efficiency of a computing device by intelligently distributing portions of machine learning workloads from an Edge server to one or more Edge elements (e.g., Edge servers, Edge load balancers, Edge endpoint devices). Furthermore, the techniques describe herein improve performance of deep learning workloads and/or any other Edge workload by effectively using dynamic and static data. Disclosed examples additionally reduce application traffic on Edge servers and reduce response latency for deep learning applications.

Disclosed systems, methods, apparatus, and articles of manufacture are accordingly directed to one or more improvement(s) in the operation of a machine such as a computer or other electronic and/or mechanical device.

Example methods, apparatus, systems, and articles of manufacture to load balance edge device workloads are disclosed herein. Further examples and combinations thereof include the following:

Example 1 includes an apparatus comprising at least one memory, instructions, and processor circuitry to execute the instructions to extract static and dynamic data from a packet associated with a request for service by an edge device, the static data to change less frequently than the dynamic data, generate a first plurality of probability distributions with a first machine learning model using the static data, generate a second plurality of probability distributions with a second machine learning model using the dynamic data, calculate a confidence value for a first helper compute unit of a plurality of helper compute units, the confidence value indicating a likelihood the first helper compute unit can satisfy the request for service more quickly than other helper compute units of the plurality of helper compute units, the confidence value calculated based on the first and second plurality of probability distributions, and assign the first helper compute unit the request for service based on the confidence value.

Example 2 includes the apparatus of example 1, wherein the processor circuitry is to execute the instructions to calculate confidence values for each of the plurality of helper compute units, the first helper compute unit assigned the request for service based on having a greatest confidence value of the plurality of helper compute units.

Example 3 includes the apparatus of any of the preceding clauses, wherein the first and second machine learning models are bayesian machine learning models.

Example 4 includes the apparatus of any of the preceding clauses, wherein to calculate the confidence value for the first helper compute unit, the processor circuitry is to execute the instructions to determine a first average and a first standard deviation of a first probability distribution of the first plurality of probability distributions, determine a second average and a second standard deviation of a first probability distribution of the second plurality of probability distributions, add the first and second averages, and subtract the first and second standard deviations.

Example 5 includes the apparatus of any of the preceding clauses, wherein the static and dynamic data is first static and dynamic data, and wherein the processor circuitry is to execute the instructions to log second static and dynamic data for a threshold period, perform inference with a third machine learning model using the second static and dynamic data, log associations between the second static and dynamic data and corresponding helper compute units, the corresponding helper compute units selected based on the third inference, and generate a training data set including the static and dynamic data, indications of the selected helper compute units, and the associations.

Example 6 includes the apparatus of any of the preceding clauses, wherein the third machine learning model is a non-bayesian machine learning model and the threshold period is either a sample quantity or a time period.

Example 7 includes the apparatus of any of the preceding clauses, wherein the static data includes a device identifier, a device type, and application type, wherein the dynamic data includes a geographic location and time data, and wherein the processor circuitry is to execute the instructions to normalize the confidence values, and generate a probabilistic graph that represents the confidence values as edges of the probabilistic graph and the helper compute units as nodes of the probabilistic graph.

Example 8 includes a computer readable medium comprising instructions which, when executed, cause processor circuitry to extract static and dynamic data from a packet associated with a request for service by an edge device, the static data to change less frequently than the dynamic data, generate a first plurality of probability distributions with a first machine learning model using the static data, generate a second plurality of probability distributions with a second machine learning model using the dynamic data, calculate a confidence value for a first helper compute unit of a plurality of helper compute units, the confidence value indicating a likelihood the first helper compute unit can satisfy the request for service more quickly than other helper compute units of the plurality of helper compute units, the confidence value calculated based on the first and second plurality of probability distributions, and assign the first helper compute unit the request for service based on the confidence value.

Example 9 includes the computer readable medium of any of the preceding clauses, wherein the instructions, when executed, cause the processor circuitry to calculate confidence values for each of the plurality of helper compute units, the first helper compute unit assigned the request for service based on having a greatest confidence value of the plurality of helper compute units.

Example 10 includes the computer readable medium of any of the preceding clauses, wherein the first and second machine learning models are bayesian machine learning models.

Example 11 includes the computer readable medium of any of the preceding clauses, wherein to calculate the confidence value for the first helper compute unit, the instructions, when executed, cause the processor circuitry to determine a first average and a first standard deviation of a first probability distribution of the first plurality of probability distributions, determine a second average and a second standard deviation of a first probability distribution of the second plurality of probability distributions, add the first and second averages, and subtract the first and second standard deviations.

Example 12 includes the computer readable medium of any of the preceding clauses, wherein the static and dynamic data is first static and dynamic data, and wherein the instructions, when executed, cause the processor circuitry to log second static and dynamic data for a threshold period, perform inference with a third machine learning model using the second static and dynamic data, log associations between the second static and dynamic data and corresponding helper compute units, the corresponding helper compute units selected based on the third inference, and generate a training data set including the static and dynamic data, indications of the selected helper compute units, and the associations.

Example 13 includes the computer readable medium of any of the preceding clauses, wherein the third machine learning model is a non-bayesian machine learning model and the threshold period is either a sample quantity or a time period.

Example 14 includes the computer readable medium of any of the preceding clauses, wherein the static data includes a device identifier, a device type, and application type, wherein the dynamic data includes a geographic location and time data, and wherein the instructions, when executed, cause the processor circuitry to normalize the confidence values, and generate a probabilistic graph that represents the confidence values as edges of the probabilistic graph and the helper compute units as nodes of the probabilistic graph.

Example 15 includes a method comprising extracting, by executing an instruction with processor circuitry, static and dynamic data from a packet associated with a request for service by an edge device, the static data to change less frequently than the dynamic data, generating, by executing an instruction with the processor circuitry, a first plurality of probability distributions with a first machine learning model using the static data, generating, by executing an instruction with the processor circuitry, a second plurality of probability distributions with a second machine learning model using the dynamic data, calculating, by executing an instruction with the processor circuitry, a confidence value for a first helper compute unit of a plurality of helper compute units, the confidence value indicating a likelihood the first helper compute unit can satisfy the request for service more quickly than other helper compute units of the plurality of helper compute units, the confidence value calculated based on the first and second plurality of probability distributions, and assigning, by executing an instruction with the processor circuitry, the first helper compute unit the request for service based on the confidence value.

Example 16 includes the method of any of the preceding clauses, further including calculating confidence values for each of the plurality of helper compute units, the first helper compute unit assigned the request for service based on having a greatest confidence value of the plurality of helper compute units.

Example 17 includes the method of any of the preceding clauses, wherein the first and second machine learning models are bayesian machine learning models.

Example 18 includes the method of any of the preceding clauses, wherein to calculate the confidence value for the first helper compute unit further includes determining a first average and a first standard deviation of a first probability distribution of the first plurality of probability distributions, determining a second average and a second standard deviation of a first probability distribution of the second plurality of probability distributions, adding the first and second averages, and subtracting the first and second standard deviations.

Example 19 includes the method of any of the preceding clauses, wherein the static and dynamic data is first static and dynamic data, and further including logging second static and dynamic data for a threshold period, performing inference with a third machine learning model using the second static and dynamic data, logging associations between the second static and dynamic data and corresponding helper compute units, the corresponding helper compute units selected based on the third inference, and generating a training data set including the static and dynamic data, indications of the selected helper compute units, and the associations.

Example 20 includes the method of any of the preceding clauses, wherein the third machine learning model is a non-bayesian machine learning model and the threshold period is either a sample quantity or a time period.

Example 21 includes the method of any of the preceding clauses, wherein the static data includes a device identifier, a device type, and application type, wherein the dynamic data includes a geographic location and time data, and further including normalizing the confidence values, and generating a probabilistic graph that represents the confidence values as edges of the probabilistic graph and the helper compute units as nodes of the probabilistic graph.

Example 22 includes an apparatus for load balancing edge workloads, the apparatus comprising means for extracting static and dynamic data from a packet associated with a request for service by an edge device, the static data to change less frequently than the dynamic data, first means for generating a first plurality of probability distributions with a first machine learning model using the static data, second means for generating a second plurality of probability distributions with a second machine learning model using the dynamic data, means for calculating a confidence value for a first helper compute unit of a plurality of helper compute units, the confidence value indicating a likelihood the first helper compute unit can satisfy the request for service more quickly than other helper compute units of the plurality of helper compute units, the confidence value calculated based on the first and second plurality of probability distributions, and means for assigning the first helper compute unit the request for service based on the confidence value.

Example 23 includes the apparatus of any of the preceding clauses, wherein the means for calculating is to calculate confidence values for each of the plurality of helper compute units, the first helper compute unit assigned the request for service based on having a greatest confidence value of the plurality of helper compute units.

Example 24 includes the apparatus of any of the preceding clauses, wherein the first and second machine learning models are bayesian machine learning models.

Example 25 includes the apparatus of any of the preceding clauses, wherein the means for calculating is to calculate the confidence value of the first helper compute unit by determining a first average and a first standard deviation of a first probability distribution of the first plurality of probability distributions, determining a second average and a second standard deviation of a first probability distribution of the second plurality of probability distributions, adding the first and second averages, and subtracting the first and second standard deviations.

Example 26 includes the apparatus of any of the preceding clauses, wherein the static and dynamic data is first static and dynamic data, and further including means for logging to log second static and dynamic data for a threshold period, and log associations between the second static and dynamic data and corresponding helper compute units, the corresponding helper compute units selected based on the third inference, means for performing inference with a third machine learning model using the second static and dynamic data, and third means for generating a training data set including the static and dynamic data, indications of the selected helper compute units, and the associations.

Example 27 includes the apparatus of any of the preceding clauses, wherein the third machine learning model is a non-bayesian machine learning model and the threshold period is either a sample quantity or a time period.

Example 28 includes the apparatus of any of the preceding clauses, wherein the static data includes a device identifier, a device type, and application type, wherein the dynamic data includes a geographic location and time data, and further including means for normalizing the confidence values, and fourth means for generating a probabilistic graph that represents the confidence values as edges of the probabilistic graph and the helper compute units as nodes of the probabilistic graph.

The following claims are hereby incorporated into this Detailed Description by this reference. Although certain example systems, methods, apparatus, and articles of manufacture have been disclosed herein, the scope of coverage of this patent is not limited thereto. On the contrary, this patent covers all systems, methods, apparatus, and articles of manufacture fairly falling within the scope of the claims of this patent.

1. An apparatus comprising:
at least one memory;
instructions; and
processor circuitry to execute the instructions to:
extract static and dynamic data from a packet associated with a request for service by an edge device, the static data to change less frequently than the dynamic data;
generate a first plurality of probability distributions with a first machine learning model using the static data;
generate a second plurality of probability distributions with a second machine learning model using the dynamic data;
calculate a confidence value for a first helper compute unit of a plurality of helper compute units, the confidence value indicating a likelihood the first helper compute unit can satisfy the request for service more quickly than other helper compute units of the plurality of helper compute units, the confidence value calculated based on the first and second plurality of probability distributions; and
assign the first helper compute unit the request for service based on the confidence value.

2. The apparatus of claim 1, wherein the processor circuitry is to execute the instructions to calculate confidence values for each of the plurality of helper compute units, the first helper compute unit assigned the request for service based on having a greatest confidence value of the plurality of helper compute units.

3. The apparatus of claim 2, wherein the first and second machine learning models are bayesian machine learning models.

4. The apparatus of claim 3, wherein to calculate the confidence value for the first helper compute unit, the processor circuitry is to execute the instructions to:
determine a first average and a first standard deviation of a first probability distribution of the first plurality of probability distributions;
determine a second average and a second standard deviation of a first probability distribution of the second plurality of probability distributions;
add the first and second averages; and
subtract the first and second standard deviations.

5. The apparatus of claim 3, wherein the static and dynamic data is first static and dynamic data, and wherein the processor circuitry is to execute the instructions to:
log second static and dynamic data for a threshold period;
perform inference with a third machine learning model using the second static and dynamic data;
log associations between the second static and dynamic data and corresponding helper compute units, the corresponding helper compute units selected based on the third inference; and
generate a training data set including the static and dynamic data, indications of the selected helper compute units, and the associations.

6. The apparatus of claim 5, wherein the third machine learning model is a non-bayesian machine learning model and the threshold period is either a sample quantity or a time period.

7. The apparatus of claim 3, wherein the static data includes a device identifier, a device type, and application type, wherein the dynamic data includes a geographic location and time data, and wherein the processor circuitry is to execute the instructions to:
normalize the confidence values; and
generate a probabilistic graph that represents the confidence values as edges of the probabilistic graph and the helper compute units as nodes of the probabilistic graph.

8. A non-transitory computer readable medium comprising instructions which, when executed, cause processor circuitry to:
extract static and dynamic data from a packet associated with a request for service by an edge device, the static data to change less frequently than the dynamic data;
generate a first plurality of probability distributions with a first machine learning model using the static data;
generate a second plurality of probability distributions with a second machine learning model using the dynamic data;
calculate a confidence value for a first helper compute unit of a plurality of helper compute units, the confidence value indicating a likelihood the first helper compute unit can satisfy the request for service more quickly than other helper compute units of the plurality of helper compute units, the confidence value calculated based on the first and second plurality of probability distributions; and
assign the first helper compute unit the request for service based on the confidence value.

9. The non-transitory computer readable medium of claim 8, wherein the instructions, when executed, cause the processor circuitry to calculate confidence values for each of the plurality of helper compute units, the first helper compute unit assigned the request for service based on having a greatest confidence value of the plurality of helper compute units.

10. The non-transitory computer readable medium of claim 9, wherein the first and second machine learning models are bayesian machine learning models.

11. The non-transitory computer readable medium of claim 10, wherein to calculate the confidence value for the first helper compute unit, the instructions, when executed, cause the processor circuitry to:
determine a first average and a first standard deviation of a first probability distribution of the first plurality of probability distributions;
determine a second average and a second standard deviation of a first probability distribution of the second plurality of probability distributions;
add the first and second averages; and
subtract the first and second standard deviations.

12. The non-transitory computer readable medium of claim 10, wherein the static and dynamic data is first static and dynamic data, and wherein the instructions, when executed, cause the processor circuitry to:
log second static and dynamic data for a threshold period;
perform inference with a third machine learning model using the second static and dynamic data;
log associations between the second static and dynamic data and corresponding helper compute units, the corresponding helper compute units selected based on the third inference; and
generate a training data set including the static and dynamic data, indications of the selected helper compute units, and the associations.

13. The non-transitory computer readable medium of claim 12, wherein the third machine learning model is a non-bayesian machine learning model and the threshold period is either a sample quantity or a time period.

14. The non-transitory computer readable medium of claim 10, wherein the static data includes a device identifier, a device type, and application type, wherein the dynamic data includes a geographic location and time data, and wherein the instructions, when executed, cause the processor circuitry to:
normalize the confidence values; and
generate a probabilistic graph that represents the confidence values as edges of the probabilistic graph and the helper compute units as nodes of the probabilistic graph.

15. A method comprising:
extracting, by executing an instruction with processor circuitry, static and dynamic data from a packet associated with a request for service by an edge device, the static data to change less frequently than the dynamic data;
generating, by executing an instruction with the processor circuitry, a first plurality of probability distributions with a first machine learning model using the static data;
generating, by executing an instruction with the processor circuitry, a second plurality of probability distributions with a second machine learning model using the dynamic data;
calculating, by executing an instruction with the processor circuitry, a confidence value for a first helper compute unit of a plurality of helper compute units, the confidence value indicating a likelihood the first helper compute unit can satisfy the request for service more quickly than other helper compute units of the plurality of helper compute units, the confidence value calculated based on the first and second plurality of probability distributions; and
assigning, by executing an instruction with the processor circuitry, the first helper compute unit the request for service based on the confidence value.

16. The method of claim 15, further including calculating confidence values for each of the plurality of helper compute units, the first helper compute unit assigned the request for service based on having a greatest confidence value of the plurality of helper compute units.

17. The method of claim 16, wherein the first and second machine learning models are bayesian machine learning models.

18. The method of claim 17, wherein to calculate the confidence value for the first helper compute unit further includes:
determining a first average and a first standard deviation of a first probability distribution of the first plurality of probability distributions;
determining a second average and a second standard deviation of a first probability distribution of the second plurality of probability distributions;
adding the first and second averages; and
subtracting the first and second standard deviations.

19.-21. (canceled)

22. An apparatus for load balancing edge workloads, the apparatus comprising:
means for extracting static and dynamic data from a packet associated with a request for service by an edge device, the static data to change less frequently than the dynamic data;
first means for generating a first plurality of probability distributions with a first machine learning model using the static data;
second means for generating a second plurality of probability distributions with a second machine learning model using the dynamic data;
means for calculating a confidence value for a first helper compute unit of a plurality of helper compute units, the confidence value indicating a likelihood the first helper compute unit can satisfy the request for service more quickly than other helper compute units of the plurality of helper compute units, the confidence value calculated based on the first and second plurality of probability distributions; and
means for assigning the first helper compute unit the request for service based on the confidence value.

23. The apparatus of claim 22, wherein the means for calculating is to calculate confidence values for each of the plurality of helper compute units, the first helper compute unit assigned the request for service based on having a greatest confidence value of the plurality of helper compute units.

24. The apparatus of claim 23, wherein the first and second machine learning models are bayesian machine learning models.

25. The apparatus of claim 24, wherein the means for calculating is to calculate the confidence value of the first helper compute unit by:
determining a first average and a first standard deviation of a first probability distribution of the first plurality of probability distributions;
determining a second average and a second standard deviation of a first probability distribution of the second plurality of probability distributions;
adding the first and second averages; and
subtracting the first and second standard deviations.

26. The apparatus of claim 24, wherein the static and dynamic data is first static and dynamic data, and further including:
means for logging to:
log second static and dynamic data for a threshold period; and
log associations between the second static and dynamic data and corresponding helper compute units, the corresponding helper compute units selected based on the third inference;
means for performing inference with a third machine learning model using the second static and dynamic data; and
third means for generating a training data set including the static and dynamic data, indications of the selected helper compute units, and the associations.

27. The apparatus of claim 26, wherein the third machine learning model is a non-bayesian machine learning model and the threshold period is either a sample quantity or a time period.

28. The apparatus of claim 26, wherein the static data includes a device identifier, a device type, and application type, wherein the dynamic data includes a geographic location and time data, and further including:
means for normalizing the confidence values; and
fourth means for generating a probabilistic graph that represents the confidence values as edges of the probabilistic graph and the helper compute units as nodes of the probabilistic graph.
